(19) United States
(12) Patent Application Publication
(10) Pub. No.: US 2019/0138194 A1
(43) Pub. Date: May 9, 2019

(54) APPARATUS AND METHODS FOR A USER INTERFACE

(71) Applicant: WATTL LIMITED, Cheshire (GB)

(72) Inventor: Matthew David RYAN, Cheshire (GB)

(21) Appl. No.: 16/099,959

(22) PCT Filed: May 8, 2017
(86) PCT No.: PCT/IB2017/052671

§ 371 Date: Nov. 8, 2018

(30) Foreign Application Priority Data
May 9, 2016 (GB) 1608051.7

(51) Int. Cl. G06F 3/0484

(52) U.S. Cl. CPC G06F 3/04847; G06F 2203/04806

(57) ABSTRACT

There is presented methods and apparatus for updating a collection of data associated with a pre-defined framework of representations on a user interface. Also presented are apparatus and a method for activating an activatable data object. The activatable data object being a data object of a collection of nested data objects. Also presented are apparatus and a method for updating one or more representations stored on a first device. The one or more representations for outputting on a user interface hosted by the first device. The representations being at least part of a collection of representations navigable via the user interface. Also presented is a method and apparatus for generating a representation for outputting on a user interface. The representation being for a collection of representations navigable via the user interface.

### FIELD OF THE INVENTION

The present application is in the field of user interfaces, generating or updating data for one or more user interfaces, for example, generating one or more representations for outputting on a user interface. The present application is also in the field of activating a data objects associated with a user interface.

### BACKGROUND

Many people have Internet connected devices, such as mobile phones and laptop computers, and it is common for people to share media content, such as photos and video. This is achieved by users sharing their media in a way that lets other users view the media.

When a user shares an item, this is usually accompanied by some kind of notification (e.g. by email, mobile push notification or SMS). Accordingly the shared media is made available to the recipients either by appearing in the recipients private account (e.g. news feed), or by being presented in a public facing way (e.g. a forum).

Due to the huge numbers of users of such systems, large volumes of media is shared, so some means of filtering is employed. In the case of publicly shared content, filtering is usually achieved by using meta-data (e.g. tags, geo-location, image processing, keywords).

The requirement for filtering due to the high volume of media presents an issue if either the meta-data authoring is incorrect, or the filter term is mismatched to the metadata.

In addition, traditional media sharing platforms store media indefinitely, to allow users to access the media at any time, which causes increased storage requirements leading to increased costs and system complexity.

When discussing media sharing, there are three primary modes of operation. Firstly there is authoring, which refers to the users who create and distribute the content. Secondly, searching refers to users looking for specific content by using meta-data criteria (such as keyword search, geo-location etc.). Lastly, browsing refers to the users who spend time exploring content without any particular search terms in mind.

Browsing is normally implemented using criteria such as meta-data similarity (e.g. content with the same tags), social metrics (e.g. what people who liked this content also liked) and by using trending data (e.g. by presenting content that is currently popular).

### SUMMARY

According to a first aspect of the present invention there is provided a method for updating a collection of data associated with a pre-defined framework of representations; the framework configured to be: output by one or more user interfaces; and, navigable by one or more users using the said one or more user interfaces; each representation being associated with a different position within the said framework; the data in the collection arranged into a plurality of data groups wherein each data group comprises one or more of the data from the said collection, wherein each data group is associated with a different representation of the said framework wherein the representation is based at least upon a data of the associated data group; the method comprises using a processor to: determine a parameter associated with a first of the said data groups, the parameter based on one or more actions performed, on or using, data associated with the first data group; update the collection of data at a time based on the parameter, by removing: at least of one of the data from the first data group; wherein at least one of the removed data comprising the data associated with the representation of the first data group; the representation associated with the first data group from the framework.

The first aspect may be modified in any suitable way as disclosed herein including but not limited to any one or more of the following.

The method may be configured to use the processor to: determine a separate said parameter for each of the data groups, determine a separate time value associated with each said parameter; for each of the data groups, update the collection of data at a time based on the time value, by removing at least of one of the data from the respective data group of data; at least one of the removed data comprising the data associated with the representation of the said data group.

The method may comprise: determining a time value associated with the said parameter; determining the said time based on the time value.

The method may be configured such that the data associated with the first data group comprises least one of the data in the said first data group.

The method may be configured such that updating the collection comprises removing the first data group from the collection.

The method may comprise, after removing the first data group, inputting a further data group into the said collection; the further data group associated with a further representation having the same framework position as the representation associated with the removed first data group.

The method may comprise removing the at least one of the data from the first data group after expiration of the time value.

The method may be configured such that wherein determining the said parameter comprises updating an existing parameter associated with the first data group.

The method may be configured such that the said one or more actions comprise actions performed by one or more of the said users.

The method may be configured such that the said one or more action comprise an action initiated by a user navigating the said framework with the user interface.

The method may be configured such that the said one or more actions comprises any one or more of: a search performed on at least one of the data of the first data group; a selection of the first data group by the user; a output of the associated representation on the user interface; a change in at least one of the data of the first data group.

The method may be configured such that the said one or more actions occurred after the generation of the associated representation of the first data group. The method may be configured such that the framework is configured to be output to a plurality of user interface devices.

The method may be configured such that at least one of the data groups comprises data uploaded by a user via the user interface.

The method may be configured such that at least one data from at least one of the groups comprises first data and wherein another data from the said group comprises metadata associated with the first data.

The method may be configured such that at least one of the data in the first group is stored on a database. The method may be configured such that the first data and its metadata are stored on the database. The method may be configured such that the data source of at least one data from the group is a data object stored on a memory device.

The method may be configured such that the first data comprises a stream of data received from a remote source. The method may be configured such that the remote source is configured to output the stream of data to the one or more user interface devices. The method may be configured such that the first data comprises media content. The method may be configured such that the first data comprises image data. The method may be configured such that the first data comprises movie image data.

The method may be configured such that the movie image data is streamed from a remote source. The method may be configured such that at least one of the data from at least one of the said data groups comprises data for outputting as the associated representation for the group. The method may be configured such that the at least one representation is generated at least from data of its associated data group.

The method may be configured such that the user interface is a graphical user interface. The method may be configured such that the representations comprise graphical representations. The method may be configured such that the framework comprises a two dimensional grid. The method may be configured such that the framework comprises a grid of rectangular graphical representations. The method may be configured such that the framework comprises a fixed number of representations.

According to a second aspect of the present invention there is provided an apparatus for updating a collection of data associated with a pre-defined framework of representations; the framework configured to be: output by one or more user interfaces; and, navigable by one or more users using the said one or more user interfaces; each representation being associated with a different position within the said framework; the data in the collection arranged into a plurality of data groups wherein each data group comprises one or more of the data from the said collection, wherein each data group is associated with a different representation of the said framework wherein the representation is based at least upon a data of the associated data group; the apparatus comprising a processor running a software application configured to: determine a parameter associated with a first of the said data groups, the parameter based on one or more actions performed, on or using, data associated with the first data group; update the collection of data at a time based on the parameter, by removing: at least of one of the data from the first data group; wherein at least one of the removed data comprising the data associated with the representation of the first data group; the representation associated with the first data group from the framework.

The second aspect may be modified in any suitable way as disclosed herein including but not limited to any one or more of the optional features of the first aspect described above.

There is also presented a non-transient computer readable medium comprising program code, which when executed by a processor is configured to cause the processor to give effect to the method as claimed in the first aspect. According to the third aspect of the present invention there is provided a method for activating an activatable data object; the activatable data object being a data object of a collection of nested data objects wherein each data object in the collection is linked to at least one other data object from the said collection; wherein a first data object of the collection is associated with: a position on a user interface; and, a first plurality of further data objects from the collection; wherein each of the data objects from the said first plurality is associated with at least one different predetermined direction on the user interface from the said position associated with the first data object; the method comprising: receiving a first signal associated with a first position on the user interface device; receiving a second signal associated with a second position on the user interface device that is different from the first position; and, using a processor to: determine a direction on the user interface by comparing the first position to the second position; select a data object from the said first plurality based on at least the said determined direction and at least one of the said predetermined directions associated with the first plurality of further data objects; activate the selected data object.

The third aspect may be modified in any suitable way as disclosed herein including but not limited to any one or more of the following.

The method may be configured such that the position associated with the first data object is the first position.

The method may be configured such that each data object of the collection is linked to at least another data object such that a user is able to access, via the user interface device, one of the data objects via selecting the other of the data objects.

The method may be configured such that a further data object from the collection is associated with: a further plurality of data objects from the said collection, the further plurality comprising the first data object and comprising different data objects from the first plurality; a further position of the user interface device different from the first position; the further data object being different from the: first data object, the data objects of the first plurality; wherein each of the data objects from the said further plurality is associated, on the user interface device, with a different predetermined spatial relationship with the further position from the other data objects of the said further plurality; the method comprising: receiving a further input signal associated with the further position on the user interface device; using the processor to: select the first data object from the said further plurality based on at least on the first and further input signals.

A method may be configured such that the user interface is a touch sensitive user interface; the method comprising: receiving a first signal from the user interface device; the first signal associated with a touch input on the touch sensitive user interface device at the first position; receiving a second signal from the user interface device; the second signal associated with a touch input at a second position on the user interface device that is different from the first position.

The method may be configured such that the user interface comprises a graphical user interface.

The method may be configured such that each of the data objects in the said collection is associated with a predetermined position on the user interface.

The method may be configured such that each of the data objects of the first plurality are associated with a different position on the user interface.

The method may be configured such that the second position is co-located with the position of the selected data object.

The method may comprise: comparing the second position with at least one of the positions associated with the first plurality of the said interactive data objects; selecting the data object from the first plurality at least based upon the said comparison.

The method may be configured such that the selected data object from the first plurality is configured to initiate an executable computational operation when activated.

The method may be configured such that each of the data objects from the said first plurality is associated with a different spatial relationship on the user interface device from the first data object.

According to a fourth aspect of the present invention there is provided an apparatus comprising: a user interface for receiving user input at, at least, a first and second position on the user interface; the apparatus configured to activate an activatable data object; the activatable data object being a data object of a collection of nested data objects wherein each data object in the collection is linked to at least one other data object from the said collection; wherein a first data object of the collection is associated with: a position on the user interface; and, a first plurality of further data objects from the collection; wherein each of the data objects from the said first plurality is associated with at least one different predetermined direction on the user interface from the said position associated with the first data object; the apparatus comprising a processor configured to run a software application configured to: receive a first signal associated with a first position on the user interface; receive a second signal associated with a second position on the user interface that is different from the first position; and, determine a direction on the user interface by comparing the first position to the second position; select a data object from the said first plurality based on at least the said determined direction and at least one of the said predetermined directions associated with the first plurality of further data objects; activate the selected data object.

The fourth aspect may be modified in any suitable way as disclosed herein including but not limited to any one or more of the optional features described for the third aspect.

According to a fifth aspect of the present invention there is provided a method for activating a data object; the method comprising: receiving a sequence of input signals; each input signal associated with a different position on a user interface to adjacent signals in the sequence; comparing the sequence to a nested arrangement of data objects; the nested arrangement comprising a plurality of groups of one or more of the said data objects; each group being linked to another group; each data object in each group being associated with a different position on the user interface; wherein, for at least one group of data objects, each data object in the said group is arranged about the user interface at: a different position to a data object from the previous nested level; and, at a different angle from the said data object from the previous nested level: determining an angle from the sequence of input signals; comparing the determined angle to the above-said different angles of the data objects of the at least one group, selecting a data object based on the said comparison; activating the selected data object. The fifth aspect may be modified in any suitable way as disclosed herein.

According to a sixth aspect of the present invention there is provided a method for updating one or more representations stored on a first device, the one or more representations for outputting on a user interface hosted by the first device; the representations being at least part of a collection of representations navigable via the user interface; the first device configured to communicate with a second device remote from the first device; the said representations of the collection being arranged into at least one representation group wherein: each representation group is associated with a representation framework for outputting via the user interface; each of the representations in each representation group being associated with a different position about the respective framework; the said representations of the collection being associated with a collection of separate data groups; each data group: comprising at least a first data and metadata associated with the said first data; and, associated with a data group representation based upon any of the first data or metadata; wherein a first representation group of the said at least one representation group comprises the said data group representations; the collection of data groups configured to have different versions wherein a parameter identifying a version of the collection of data groups is stored on the first device and the second device; the method comprising: using one or more processors to compare the parameter stored on the first device with the parameter stored on the second device; and, transmitting, if the versions of the compared parameters are different, information from the second device to the first device; the information associated with a change in at least one of the data within the collection of data groups; using the said one or more processors to update the one or more representations stored on the first device based on the transmitted information. The sixth aspect may be modified in any suitable way as disclosed herein.

According to a seventh aspect of the present invention there is provided a non-transient computer readable medium comprising program code, which when executed by a processor is configured to cause the processor to give effect to the method described in the sixth aspect.

According to an eighth aspect of the present invention there is provided an apparatus comprising a first device and for updating one or more representations stored on the first device, the one or more representations for outputting on a user interface hosted by the first device; the representations being at least part of a collection of representations navigable via the user interface; the first device configured to communicate with a second device remote from the first device; the said representations of the collection being arranged into at least one representation group wherein: each representation group is associated with a representation framework for outputting via the user interface; each of the representations in each representation group being associated with a different position about the respective framework; the said representations of the collection being associated with a collection of separate data groups; each data group: comprising at least a first data and metadata associated with the said first data; and, associated with a data group representation based upon any of the first data or metadata; wherein a first representation group of the said at least one representation group comprises the said data group representations; the collection of data groups configured to have different versions wherein a parameter identifying a version of the collection of data groups is stored on the first device and the second device; the apparatus comprising a processor configured to run a software application configured to: receive a version of the parameter stored on the second device; compare the parameter stored on the first device with the received parameter stored on the second device; and, transmitting, if the versions of the compared parameters are different, a request for information from the second device; the information associated with a change in at least one of the data within the collection of data groups; and, upon receiving the information from the request, using the said processor to update the one or more representations stored on the first device based on the transmitted information. The eighth aspect may be modified in any suitable way as disclosed herein.

According to a ninth aspect of the present invention there is provided a method for generating a representation for outputting on a user interface; the representation being for a collection of representations navigable via the user interface; the said representations of the collection being: arranged into a plurality of representation groups wherein: each representation group is associated with a representation framework for outputting via the user interface; each of the representations in each representation group being associated with a different position about the respective framework; associated with a collection of separate data groups; each data group: comprising at least a first data and metadata associated with the said first data; and, associated with a data group representation based upon any of the first data or metadata; wherein a first representation group of the said plurality of representation groups comprises the said data group representations; the method comprising: generating, using a processor, at least a first representation for at least one further representation group of the said plurality of representation groups, by: selecting a plurality of representations from a different representation group, each of the selected representations: having an adjacent positional arrangement about the respective framework to at least one of the other representations in the said selection; and, being associated with at least one data group representation; wherein at least a first of the selected plurality of representations comprises moving image data; and, creating the first representation using at least the selected representations by, in any order: downscaling each of the selected representations; and, combining each of the selected representations to form the said first graphical representation; and, wherein the at least one further representation group comprises a plurality of representations each associated with a different set of data group representations. The ninth aspect may be modified in any suitable way as disclosed herein including any one or more of the following and/or any one or more of the optional features of the eleventh aspect.

The method may be configured such that the step of creating the first representation comprises creating a composite moving image representation.

The method may further comprise: determining a time period; creating a time truncated version of at least one of the moving image representations; such that each of the said selected moving image representations comprises the same time length running period.

The method may be configured such that each of the selected plurality of representations comprises moving image data.

The method may be configured such that the moving image data comprises video data.

The method may be configured such that the first and a second representation of the selected plurality of representations comprising moving image data are each associated with a data group comprising first data comprising moving image data; wherein the first and second representations are derived from the said first data of the respective data group.

According to a tenth aspect of the present invention there is provided an apparatus comprising a memory device and a processor for generating a representation for outputting on a user interface; the representation being for a collection of representations navigable via the user interface; the said representations of the collection being: arranged into a plurality of representation groups wherein: each representation group is associated with a representation framework for outputting via the user interface; each of the representations in each representation group being associated with a different position about the respective framework; associated with a collection of separate data groups; each data group: comprising at least a first data and metadata associated with the said first data; and, associated with a data group representation based upon any of the first data or metadata; wherein a first representation group of the said plurality of representation groups comprises the said data group representations; the processor configured to: generate at least a first representation for at least one further representation group of the said plurality of representation groups, by: selecting a plurality of representations from a different representation group, each of the selected representations: having an adjacent positional arrangement about the respective framework to at least one of the other representations in the said selection; and, being associated with at least one data group representation; wherein at least a first of the selected plurality of representations comprises moving image data; creating the first representation using at least the selected representations by, in any order: downscaling each of the selected representations; and, combining each of the selected representations to form the said first graphical representation; and store the first representation on the memory device; wherein the at least one further representation group comprises a plurality of representations each associated with a different set of data group representations.

The tenth aspect may be modified in any suitable way as disclosed herein including any one or more of the optional features described above for the ninth aspect.

According to an eleventh aspect of the present invention there is provided a method for generating a representation for outputting on a user interface; the representation being for a collection of representations navigable via the user interface; the said representations of the collection being: arranged into a plurality of representation groups wherein: each representation group is associated with a representation framework for outputting via the user interface; each of the representations in each representation group being associated with a different position about the respective framework; associated with a collection of separate data groups; each data group: comprising at least a first data and metadata associated with the said first data; and, associated with a data group representation based upon any of the first data or metadata; wherein a first representation group of the said plurality of representation groups comprises the said data group representations; the method comprising: generating, using a processor, at least a first representation for at least one further representation group of the said plurality of representation groups, by: selecting a plurality of representations from a different representation group, each of the selected representations: having an adjacent positional arrangement about the respective framework to at least one of the other representations in the said selection; and, being associated with at least one data group representation; and, creating the first representation using at least the selected representations by, in any order: downscaling each of the selected representations; and, combining each of the selected representations to form the said first graphical representation; wherein the at least one further representation group comprises a plurality of representations each associated with a different set of data group representations.

The eleventh aspect may be modified in any suitable way as disclosed herein including any one or more of the following.

The method may be configured such that, one representation is generated for each further representation group upon a data group representation being input into the first representation group.

The method may be configured such that each of the further representation groups comprise one or more representations that collectively comprise a downscaled version of each of the data group representations. In this way, each representation group may always have a representation associated with each of the data group representations.

The method may be configured such that a single downscaled version of each data group representation is contained within one of the representations of each of the further representations groups.

The method may be configured such that the step of: generating, using a processor, at least a first representation for at least one further representation group of the said plurality of representation groups, comprises: generating a first representation for each of the further representation groups.

The method may be configured such that wherein the step of: generating, using a processor, at least a first representation for at least one further representation group of the said plurality of representation groups; is initiated after a first data group representation is input into the respective framework of the first representation group.

The method may further comprise: identifying an existing first representation from each further representation group, wherein each identified existing representation comprises a downscaled version of an existing data group representation with the same position, about the first representation group framework, as the first data group representation that has been input into the first representation group framework; generating a further first representation for each representation group, replacing each of the identified existing first representations with the respective further first representations.

The method may comprise creating a time value associated with the input of the first data group representation; the time value for use in determining when the first data group representation is to be removed from the framework associated with the first representation group.

The method may be configured such that wherein the generated first representation replaces an existing representation at the same position within the framework of the said further representation group.

The method may comprise: identifying a change in at least one of the data of a data group associated with the plurality of representations; generating a data group representation based on the change in the said data.

The method may be configured such that the change in the at least one data comprises a change in media data.

The method may be configured such that the change in the at least one data comprises a change in metadata.

The method may be configured such that the framework comprises a grid.

The method may be configured such that the framework comprises a grid of rectangular shaped representations.

The method may be configured such that generating the first representation comprises separately downscaling each of the selected representations; and, combining each of the downscaled representations to form the first representation.

The method may be configured such that at least one data group comprises media data.

In some examples, all of the data groups comprise media data

The method may be configured such that at least one data of at least one data group comprises data received from a remote user device.

The method may be configured such that at least one data group comprises interactive data.

The method may be configured such that each data group comprises metadata associated with other data in the same group.

The method may be configured such that at least one data group representation is generated from at least one data of the respective group.

The method may be configured such that each data group representation comprises a plurality of pixels.

The method may comprise storing, at least the first representation on a data storage medium.

The method as claimed may comprise storing the said collection of representations on one or more data storage media.

The method may comprise: selecting a representation group based on a first output condition of the user interface; selecting one or more of the representations from the selected representation group based on a second output condition of the user interface; outputting the selected one or more representations to the user interface. The conditions may be associated with how the user is interacting with the user interface to access the representations, for example different viewing conditions on a graphical user interface.

The method may be configured such that the first output condition is associated with a zoom level of the user interface.

The method may comprise the step of receiving data associated with the first condition from apparatus comprising the user interface. This apparatus may be separate to and remote from the processor. The first viewing condition may therefore be a resolution level at which the user is viewing the collection of representations.

The method may be configured such that the second viewing condition is associated with one or more data group representations.

The method may be configured such that the second viewing condition is associated with the portion of the framework selected to be output by the user interface.

The method may be configured such that the at least one further group is a plurality of further groups; each of said further groups associated with different downscaled resolutions of the data group representations.

The method may be configured such that each of the further groups comprises downscaled versions of representations from a different other group.

The method may be configured such that each of the further groups is associated with a different value of a user interface output condition.

The method may be configured such that at least one of the representations is a graphical representation.

The method may be configured such that the at least one of the graphical representations is an image object.

The method may be configured such that the at least one of the graphical representations comprises a video image object

The method may be configured such that the user interface is remote from the processor.

The method may be configured such that: the selected plurality of representations comprises a plurality of moving image representations; and, the step of creating the first representation comprises creating a composite moving image representation.

The method may be configured such that the step of: selecting a plurality of representations from a different representation group, comprises selecting a plurality of moving image representations from the first representation group; the method comprising: determining a time period; creating a time truncated version of at least one of the moving image representations; such that each of the said selected video representations comprises the same time length running period.

### BRIEF DESCRIPTION OF FIGURES

Embodiments of the present invention will now be described in detail with reference to the accompanying drawings, in which:

FIG. 1 shows an example of the data contained within a cell;

FIG. 2 depicts an example of a cell coordinate space and the user interface viewport;

FIG. 3 depicts an example of a grid of two-dimensional square cells;

FIG. 4 shows an example of how a non-square image is cropped to fit inside a square cell;

FIG. 5 shows an example of how a non-square video is cropped to fit inside a square cell;

FIG. 6 shows an example of a grid of hexagonal cells;

FIG. 7 shows an example of rendering a rectangular image as a hexagon;

FIG. 8 shows an example of a three-dimensional cell grid, with cubic cells, and the viewport of the cells as seen on the client device user interface;

FIG. 9 shows an example device architecture with three smartphone clients and a combined database and media server;

FIG. 10 shows an example of a process for capturing and uploading data from a client device;

FIG. 11 shows an example device architecture with a smartphone client, desktop client, two sensor devices, media server and database server;

FIG. 12 shows an example architecture capable of live-streaming data;

FIG. 13 shows an example smartphone device;

FIG. 14 shows an example of the component parts of a standalone device;

FIG. 15 shows an example of the component parts of a server device;

FIG. 16 shows an example of a relationship between tiles at different levels, and how this is displayed on the user interface;

FIG. 17 details an example of a process for calculating the zoom level at a given scale;

FIG. 18 details an example of a process for generating tiles at each level when the presentation data associate with a cell changes;

FIG. 19 shows an example of how to create a temporary tile from lower level cached tiles;

FIG. 20 shows an example of how to create a temporary tile from a higher level cached tile;

FIG. 21 shows an example of how to calculate which tiles to invalidate when a set of cells are updated;

FIG. 22 depicts an example of a hierarchical menu system;

FIG. 23 shows an example of the menu items in steps through an example user interaction with the menu by tapping the buttons;

FIG. 24 shows an example of the menu items in steps through an example user interaction with the menu by dwelling over menu items;

FIG. 25 shows example gesture paths for selecting menu items without lifting a finger from the device or dwelling on menu items;

FIG. 26 is a flow diagram showing processing steps in a method of creating a heat map, in accordance with some embodiments;

FIG. 27 is a graphical representation of a compass feature overlaid on a graphical user interface, in accordance with some embodiments;

FIG. 28 is a flow diagram showing processing steps in a method of implementing the compass feature, in accordance with some embodiments; and

FIG. 29 is a graphical representation of a data set or search selection feature, in accordance with some embodiments.

### DETAILED DESCRIPTION

The present application is directed to finding interesting content in massive amounts of data and reducing cost associated with storing media content.

The methods presented herein combine a novel way to browse and highlight content such as trending content. The methods presented herein also aim to mitigate issues associated with data storage. The apparatus used with the methods and system described herein may include any of the following:

### Client Apparatus

A number of apparatus may be used, for example client apparatus and data storage apparatus. The apparatus may have user interfaces presenting content generated by a software application running on each apparatus. The apparatus contains a processor, and is configured to receive user inputs.

A user interface may be any type of user interface including, but not limited to those utilizing a graphical display device, for example a display on a smart phone. As another example, the graphical display may be presented via a head mounted display which utilizes head orientation or eye gaze to interact with the user interface.

The methods and systems described herein may utilize or otherwise be linked with a number of apparatus with sensors, wherein each apparatus comprises a processor and is configured to run a software application that allows the data to be captured (these apparatus may be client apparatus).

A client apparatus with sensors may be configured to be the same apparatus that has the user interface.

### Data Storage Apparatus

There may be a number of data storage apparatus that store data relating to number of cells. The cells may also be referred to as groups of data objects. The data storage apparatus may be configured such that it is contained within the client apparatus.

The client and data storage apparatus may be configured to be in remote locations, and the data is transmitted between the two by means of a computer network.

### Storing Cell Data

The data storage apparatus may be configured so the cells are distributed between a number of data storage apparatus.

The data storage apparatus may be configured so cells are wholly or partially replicated on a number of data storage apparatus.

The data storage apparatus may be configured to store data associated with each cell.

The data storage apparatus may be configured so that for a cell, it stores a reference to data stored on another apparatus connected to the Internet.

### Client Apparatus

Each client apparatus may be configured to have a touch-sensitive display, to allow the software application to receive touch gestures from the user. The data is preferably output by the display via one or more electrical signals. The client apparatus may also be termed a ‘client device’. This display may be a graphical display that is part of a user interface.

The client apparatus may also be configured to have one or more sensors as described herein. Sensors may be any suitable sensor for example, one or more sensors capable of capturing location data or a camera capable of capturing image and video data. Other sensors may include temperature sensors, humidity sensors, light-field cameras or cameras operating in non-visual wavelengths such as infra-red.

Data may be captured using multiple cameras, for example to allow 3D presentation using stereoscopic glasses. Data from multiple cameras may be combined to produce, for example high resolution, re-focusable, or high-dynamic range images or video. Other devices or apparatus may be use to facilitate the operation of sensors including one or more electronic controllers configured to drive the working of the sensor and/or receive signals from the sensor.

The client apparatus may be configured to allow the captured sensor data to be stored on the data storage apparatus.

The client apparatus may be configured to transmit live sensor data such as a live video data.

### Cells

A cell refers to a group of data having at least a piece of data and associated meta-data. There are typically a plurality of such cells that are used with the methods and systems described herein. Any of the data or metadata may be stored on a data storage apparatus. Additionally or alternatively the data within the data group may be streamed from one device to another device, for example being streamed from one client smart phone to another client smart phone. The data in the group (or cell) may be media data or another form of data. Media data may be static image data such as image files, for example JPEGs, BITMAPs. Media data may also be moving image data such as movies that are stored and then subsequently transmitted or live streamed data which may be sent/streamed directly to a device as soon as it is captured by an appropriate sensor.

The data in the group may also comprise representation data as described below. At least some of the data may be stored on a database. For example, media data, the metadata for the media data and cell representation data from one cell may be stored on a database on a data storage device remote from a plurality of client apparatus. The data storage device may be configured to be in communication with the client apparatus so that data may be sent from the data storage device to the client apparatus. In another example, one data of a cell may be a stream of data (such as a video stream) that is sent from one apparatus to another apparatus whilst the metadata is stored on a separate data storage device.

The user interface on the client apparatus may display a number of cells from the entire set of cells, using parameters to determine the cells shown on the display. The set of cells may also be referred to as a collection of cells or a collection of data groups or a collection of data arranged into a plurality of groups.

Each cell or group has a representation that allows for the presentation of the cell on the user interface. This presentation may be a visual presentation, for example via a graphical user interface. The representation is particular to the group.

For example, one data cell is a group of data having: one data object being a high resolution image of a cat (this may be referred to as the content data); another data object being a cropped low resolution image file of the same cat (this would be the cell representation that is output upon a user interface) and another data object being metadata giving the time the content data was received by the data storage and a name for the cat ‘Tufty’.

User interactions on the client apparatus may cause changes in the parameters used to determine the presented cells, thereby modifying which cells are presented on the user interface.

The cells that are represented on the user interface may have content derived from a plurality or sources or a single source. The cells could each have content data that is moving image data or static image data (or other data), each being uploaded from different sources. For example, the sources of the content data in the data cells may be uploaded by a plurality of users interacting with their own client device such as a mobile phone. The same users may also view an arrangement of the cells on the user interface of their respective mobile phones.

### Areas of Interest

An algorithm may be used to calculate areas of interest within the entire set of cells that are displayed on the user interface, allowing the user to navigate to areas of interest by interacting with the apparatus. The algorithm may be run on a processor within the same device as the user interface or on a remote device.

As the visible set of cells changes due to user interaction, data for the visible cells is retrieved from a data storage apparatus.

A client apparatus with sensors can capture data and store it as the data associated to a cell in a data storage apparatus. The captured data may be termed ‘content data’ for that particular cell.

A client apparatus can associate meta-data to a cell, which may be saved in the data storage apparatus. Other metadata may be added to the cell by other devices such as the storage device when it receives cell content data.

Through interaction with the user interface, a user can capture sensor data and cause the client apparatus to store the data associated with a cell in data storage apparatus.

For example, the client apparatus may contain a camera capable of capturing image data. When the user wishes to capture data, they navigate the cells using the user interface to bring an empty cell they wish to upload to into view. They then press on the empty cell causing an image capture user interface to be displayed. On the image capture user interface is a real-time view of the captured image data from the camera, allowing the user to orientate the camera to frame the image they which to capture. The user then presses a capture button on the user interface which causes a signal to be sent to the image capture device within the client device. The image capture device produces a digital representation of the image from the camera, and then compresses the data using an algorithm such as JPEG. The compressed data is then sent as a signal to the data storage device on the client apparatus. The client apparatus then sends the compressed JPEG image data to a remote data storage server, identified by a domain name using an HTTP post. The HTTP post contains additional meta-data, such as the x- and y-coordinates of the cell, and the ID of the user who captured the image data. Software on the remote server receives the HTTP post and sends the compressed image data as a signal to a data storage device, together with the associated meta-data. An event is triggered by the remote server when the new image data is stored, causing a second software application to start on a second remote server. The second remote server then receives the image data from the data storage device and processes the image data, as described below, to produce a square-cropped image to use as cell presentation data. It also receives the meta-data associated with the image data, and puts a new entry in a database containing the cell coordinates and user id. Further processing on the second remote server verifies the authentication of the user, by using for example a session token. As described below, the second remote server then updates the cell tiles using the newly uploaded image data.

Furthermore, through interaction with the user interface, a user can associate meta-data to cell, and cause the client apparatus to store the meta-data in the storage apparatus.

The methods and systems described herein relate to finding relevant content in a large set of data. The data can be any type of data, including single valued data, captured sampled data or live streamed data. By way of example, the data could be an image taken with a smartphone, live-streamed video captured by a CCTV camera, or weather data captured by a dedicated sensor device.

Once the data is collected, it is made available for searching by presenting a representation of the data on a user interface. As examples, the user interface could be a tactile display on a smartphone, a monitor on a desktop PC, or a 3D system rendered by means of a head-mounted display.

The set of data may be arranged into cells displayable as a framework of representations as described elsewhere herein. The number of available cells in each set may be fixed.

Users can navigate around the data by moving through the representation of the data by interacting with the presentation device, for example by using a touch-sensitive display, keypad or hand-held controller.

### Cell Data

With reference to FIG. 1, each piece of data is represented as a cell 100, which contains data 102, presentation content 104 and meta-data 106.

The data content 102 of a cell is the data associated with this cell. Any type of data can be associated with a cell including stored data captured from a sensor such as an image, video, temperature, air pressure or magnetic field strength and direction. The data could be live-streamed data such as video or any data captured by a sensor. The data can be multi-dimensional, to allow capturing of a vector field.

The presentation content 104 is a visual, aural or other sensory representation of the data associated with the cell. For example, if the cell data content is an image, the presentation data could a lower resolution, cropped version of the full image. If the cell data is a video, the presentation data could be a portion of the full video that is continually replayed after it has finished (i.e. it is looped). One example is looping a 10-second segment of the full video, taken from the middle part of the video. If the cell data is magnetic field strength, then the presentation data could be an image with a background colour representing the field strength, such that black represents a low strength, yellow a middle strength, and red a high strength. In the following, the data associated with the cells relates to both the cell data (such as original uploaded videos) and the presentation data (such as cropped images).

The cell data may also contain a reference to data stored remotely, for example by using a URL to reference a web page on the Internet. In the case of remote data, the presentation data could be a generated image of the data, for example a screenshot of the referenced webpage.

In one example the data associated with the cells is stored on a file system such as a magnetic disk, but is not limited to magnetic media, for example it may be solid state media such as SSD or compact flash. Data is stored on the storage media in file chunks, and the location of file chunks are stored in file allocation table that is also saved on the media. Each file is a collection of file chunks, and is referenced by a file within a folder structure. Cell data can be saved in a folder named “/cell_data” with a separate sub-folder for each group of cells, and then a separate sub-folder for each cell. In this way, the video associated with the cell at coordinates (37,42) in the grid “AA” will be stored as “/cell_data/AA/0037_0042/video000.mp4”. If additional data is associated with the cell, this would be saved in the same folder, such as an image in “/cell_data/AA/0037_0042/image000.jpg”. The presentation data could be saved for example in the file “/cell_presentation/AA/0037_0042.jpg”.

In another example, the cell data is saved in a relational database, such as a SQL using the BLOB data type, although any type of database could be such as a graph or no-SQL database. When saved in a SQL database, the table containing the cell data could contain additional columns specifying the spatial coordinates of the cell, along with other data such as the meta-data associated with the cell. An index on the cell coordinate columns would allow fast lookup for extraction of the cell data. When saved in a database, a software application is used to extract the cell data and send it to the client device, using for example a web server running a PHP script to deliver the data over HTTP.

In another example, the cell data is stored in an online data storage provider, such as data object storage provided by Amazon S3. When the client device uploads the media, it uses HTTP post to transmit the data to the online object storage. The object storage system then stores the data in a reliable and redundant manner, making the data objects accessible via a URL such that the client devices can access the data objects using HTTP requests. When storing to an online object storage provider, each data object is referenced by a unique identifier within a container, for example the video associated with cell at coordinates (37,42) could be identified as “0037_0042_video000.mp4” within the “AA_cell_data” container. The cell presentation data could, for example be saved with the object id “0037_0042.jpg” in the “AA_cell_presentation” container.

The presentation content 104 is relevant to how the cells are presented to the user. For example, if the presentation is through a two-dimensional display, the presentation data is two-dimensional. If the presentation is via a three-dimensional display, the presentation data is three-dimensional. If the presentation includes aural content, the presentation data may be a sound. The presentation data may therefore be a re-formatted version of the full data. The reformatting may be any type of reformatting including reformatting to be presented as a representation with specific dimensions, for example reformatting to be in the correct dimensionality and/or formatted relevant to the presentation type.

The meta-data 106 is a set of data associated to the cell data content. This may include metadata such as the latitude and longitude of where the data was captured, the author of the data, any user-inputted tags or the timestamp of when the data content was captured. The meta-data is not limited to this, and can include any additional data that is associated to the cell. The meta data can be captured automatically when the data is captured, (such as GPS location), could be entered by a user (such as a text comment), or be generated automatically from the data at a later time (such as speech recognition or video recognition).

The meta-data associated with each cell could be saved in, but is not limited to a database. If a relational database was used, a table could be created that contains columns named “cellX”, “cellY”, “key” and “value”. The meta-data for each cell would be saved as rows in the database. For example, to store the caption ‘a cat’ associated with the cell (26,76), a row would be added to the table with the values {cellX=26,cellY=76,key=‘caption’,value=‘a cat’ }. Additionally, or instead, there could be a table called ‘cells’ which contains the columns needed to store all the metadata, for example “x”, “y”, “caption”, “owner”. A row in the database exists for each cell that contains data, so to save the data associated with cell (26,76) the columns would be {x=26, y=76, caption=‘a cat’, owner=‘user1245’}.

If the meta-data was stored in a graph or object database each object or node in the database would contain the metadata associated with a specific cell. For example, the node in a graph database that represents the cell (26,76) with a caption “a cat” would contain the key-value pairs “x=26, y=76, caption=“a cat”.

Each cell may optionally have a data parameter relating to activity on the cell. As described below, this allows cells that have a low level of activity to be removed therefore saving storage requirements and improve efficiency of the data storage devices.

### Cell Coordinate Space

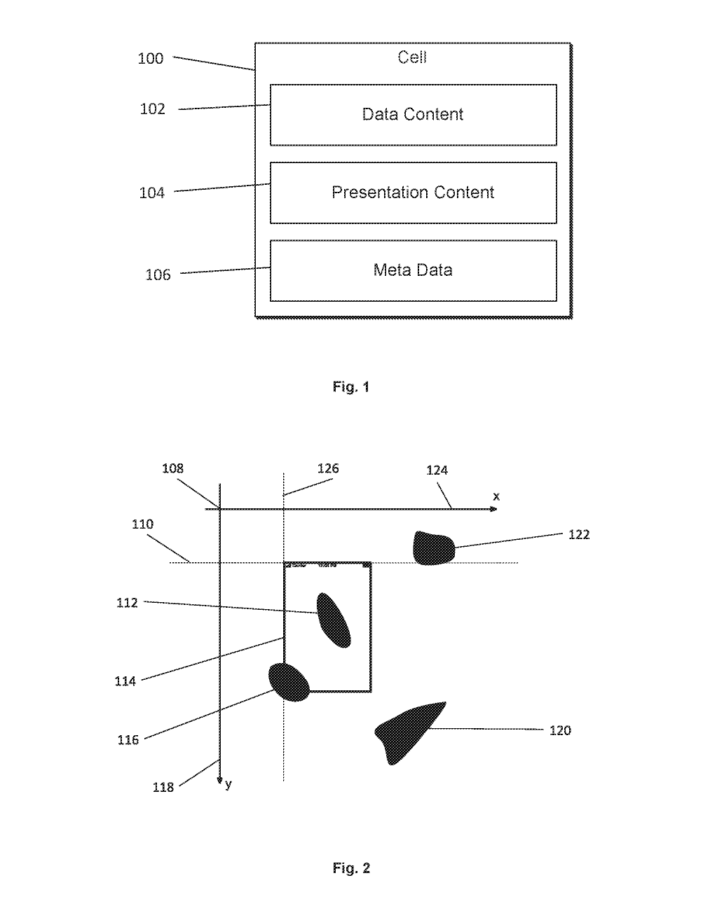

Cells are configured to be represented in an n-dimensional coordinate space. This is typically a framework or pattern of representations. The location of each cell may be defined by an n-tuple. For example, with reference to FIG. 2, the coordinate space is 2-dimensional, using a Cartesian coordinate system, such that the location of each cell (112, 116, 120 and 122) is defined by the respective location along the x-axis 124 and y-axis 118. The coordinate space that contains the cells can be any dimension, and any coordinate system could be used, such as polar or spherical coordinates. Additionally, the cells can be any shape or size, and may or may not be identical in shape and size. There can be any number of coordinate spaces, each containing any number of cells. There may be one or more grids currently displayed, which can be selected by user input, or automatically based on sensor inputs (such as GPS location).

The user interface 114 is a viewport onto the cell coordinate space, as defined by a transformation from grid coordinate space to screen coordinate space, such that

s̅=T(x̅)

Where s is the coordinates in screen space, x is the coordinate in cell space, and T is a transformation matrix.

As shown in the example of FIG. 2, the transformation may consist of an offset and scale. The offset is defined as the coordinate of the top-left corner of the viewport in the x 126 and y 110 dimensions. The scale gives the scale factor between the cell coordinate space and the screen coordinate space.

The transformation is changed to allow different regions of the cell coordinate space to be viewed on the user interface. The can be achieved, for example, by user interaction such as by using fingers on a touch-sensitive display, a keyboard or physical body movement such as eye-gaze or other user gesture. Alternatively, the transformation may be updated automatically, for example, based on the current location of the device as determined by a GPS sensor.

As an example, using a touch sensitive display the user can use multi-touch gestures to zoom and pan. By using two fingers, the scale factor is increased proportionally to the change in distance between the user's fingers. The distance between the users fingers is calculated by finding the square root of the sum of squares of the distance in x- and y- of each finger. A pinch ratio is then obtained by dividing the current distance between the users fingers by the distance when the pinch gesture began (i.e. when the users second finger touched the screen). The scale is then set to the scale when the pinch gesture began multiplied by the current pinch ratio. The offset is also adjusted according the movement of the centre-point of the users' finger, so that the cells appear to move together with the fingers on the display.

By dragging a single finger across the display, the offset is adjusted proportionally according to the distance moved by the finger. To update the offset, when a movement of the finger is detected, a delta vector is calculated as the difference between the current finger position and finger position when the last motion occurred. The x- and y-components of this vector are divided by the current scale to give a scaled motion vector. The offset is then updated by adding the scaled motion vector.

In another example, the cell coordinate space is presented through a screen located inside a head mounted device. The cell presentation data appears to the user as a 3-dimensional wall, and using the orientation of head mounted device, the viewpoint of the 3-dimensional space can be updated. The 3-dimensional images can be generated using graphics hardware running software such as OpenGL or DirectX. Orientation sensors in the head mounted device (such as accelerometer and gyroscopes) can be used to obtain the direction of the viewport. If using OpenGL, the vertex shader software can update the viewport matrix according to the roll, pitch and yaw angles of the head mounted device. When using a head mounted device, zooming can be controlled by a number of methods, such as using eye-gaze tracking, where the viewport moves forwards in the direction where the user is looking when a button on the head mounted device is pressed. Alternatively, a hand-held ‘wand’ can be used to move around the 3-dimensional space, by pressing buttons to move forward, backwards, left and right.

When presented on a two-dimensional display, the transformation may be limited such that the when fully zoomed in, a representation of a single cell fills the screen. The transformation may be at a minimum value when the user interface is fully zoomed out where the entire cell coordinate space is visible. The transformation may also be limited so that the regions outside the cell coordinate space cannot be seen.

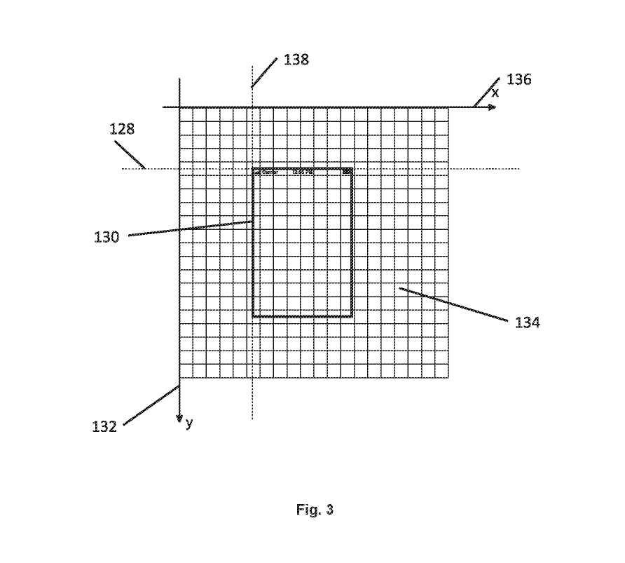

In an example implementation as shown in FIG. 3, the cells are presented as a two-dimensional square grid 134, where the grid consists of 256 by 256 cells. The location of a cell in this example is defined by its x and y coordinates according to the x-axis 136 and y-axis 132. The coordinate system is measured in points, where each cell has a size of 256×256 points, so the full grid of cells has a size of 65536×65536 points. The screen in this example has a size of 375×667 points. Other grid sizes and cell sizes may be used.

### Presentation Data

The data associated with each cell is presentable in the viewport of the display. In one example where a grid of cell representations are output, the data associated with each cell is either image or video data, although as stated elsewhere herein the data content may be other forms of data. As the cells are presented to the user as square tiles, the presentation data for each cell is an image or video that is a square-cropped version of the original.

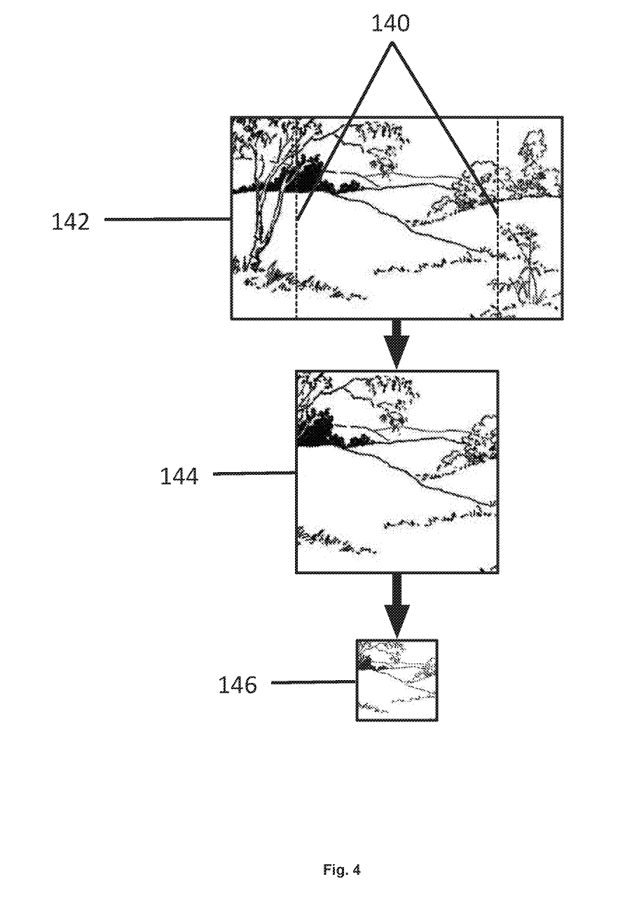

With reference to FIG. 4, where the cell data relates to an image, the original image 140 is captured on a smartphone at a resolution of 3266×2450 pixels in PNG format. The presentation image 144 is cropped from the centre of the original image, matching either the vertical or horizontal dimensions of the original image depending on which is smaller. For example if the original image is in landscape orientation, the crop region matches the height of the original image, so that parts to the left and right are cut off. Once cropped, the image is resampled to the required resolution 146, in this case 256×256 pixels. It is then encoded using JPEG encoding. Other image resizing may be used.

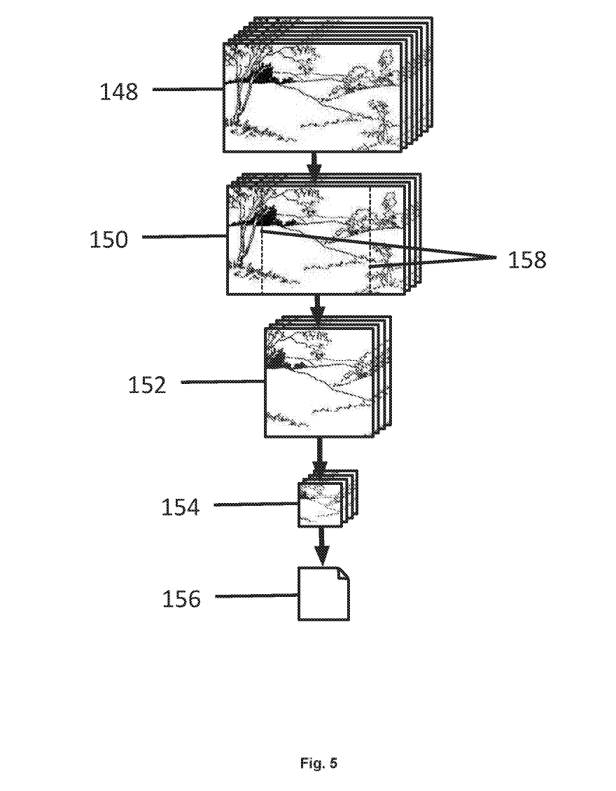

In the case of a video, as shown in the example of FIG. 5, the original video 148 may a 20-minute video captured on a smartphone, or other video of any particular length. To create the presentation data, the video is cropped in time-length to produce a shortened video, which in this example is a 10-second video 150. The video is cropped spatially along the lines 158, to create a square video 152. An algorithm may be used for cropping images to produce a square video 152. The video may then re-sampled to a different resolution 154, in this case 256×256 pixels. The video may then be encoded and saved as a compressed video file 156. Where the cell contains multiple data objects, the presentation data is a combination of the multiple data objects.

The cell may contain multiple forms of content data, for example a video and a link to a web page, combining multiple data sources into a composite presentation data. In the example of a video and web page, the presentation data could be a frame from the video, with a screenshot of the webpage as a thumbnail in the top-right corner. As another example, the cell data might be two videos, where the presentation data is a composite video of the two content videos, either sequentially or concurrently. For example, a sequential composite video would consist of 15 seconds of the first video, followed by 15 seconds of the second video. A concurrent composite video could place the videos side-by-side to produce a single video. Generally, if the cell data contains at least one moving image, the presentation will be a video, with any other static media types overlaid as thumbnail images on the video in a regular grid pattern. Alternatively, the videos could be displayed as picture-in-picture (PIP).

In another example, a composite presentation data is created by combining all the media associated with a cell into a composite data object, by allowing a user to adjust the size and location of each data object. For example, a user interface is presented to the user to place a video in the top-left, and an image to be placed bottom-right. When the placement of the cell data has been completed, a composite image or video is created to be used as the cell presentation data.

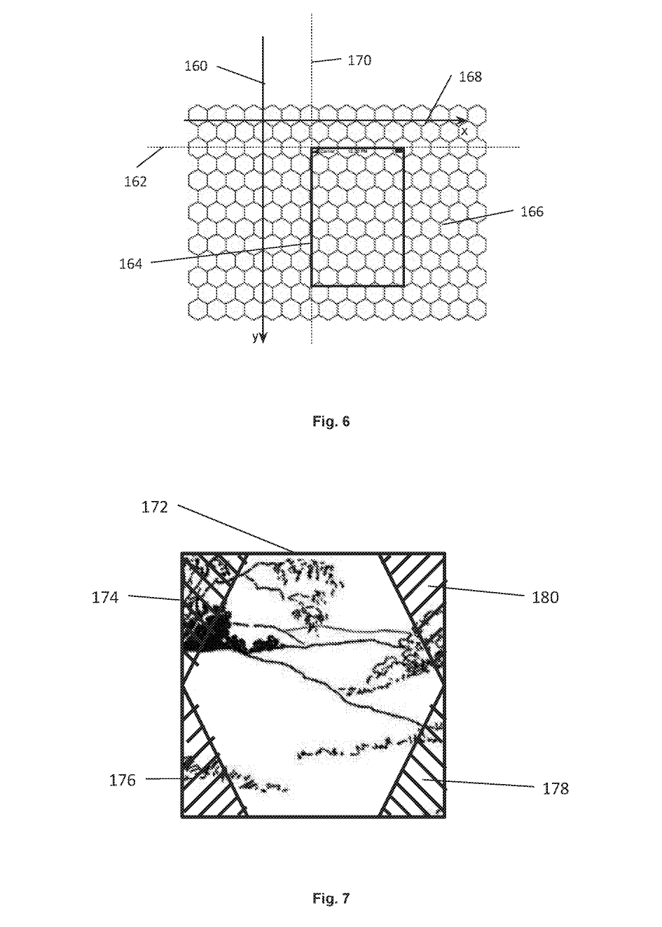

In a different implementation, with reference to FIG. 6, the cells may be hexagonal. The accompanying cropping algorithm for images and video (as shown in FIGS. 4 and 5) are similar, however the media is cropped to a rectangle such that:

$$height = \frac{\sqrt{3}}{2} \cdot width$$

An advantage with rectangular cropping is that some commonly available file formats only support rectangular images and videos. However, when the cells are rendered to the display, they are presented as a hexagon 172 as shown in FIG. 7, with the regions outside the hexagon 174, 176, 178, 180 not visible.

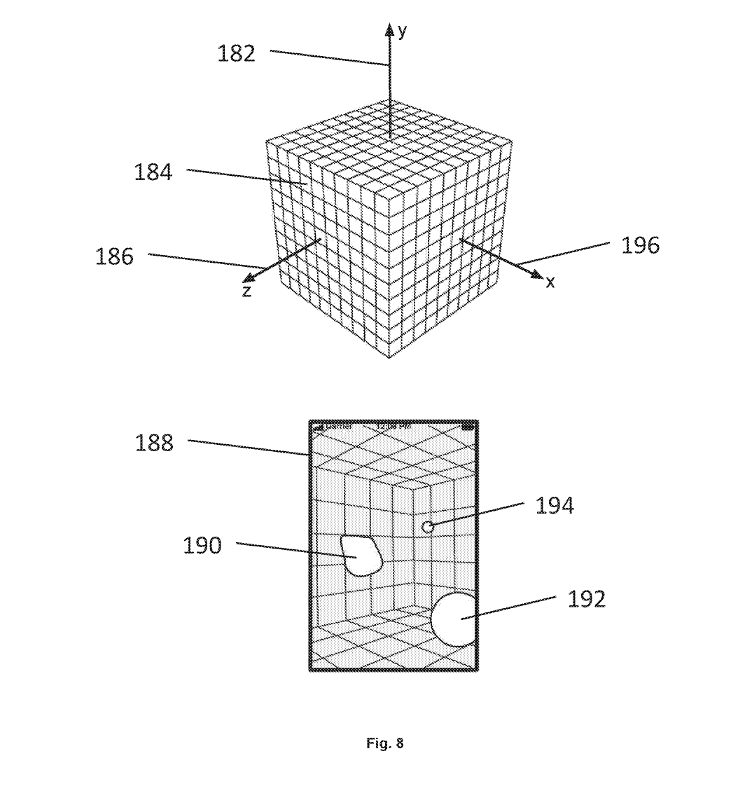

As a further example implementation shown in FIGS. 8a and 8b, the cell coordinate space is 3-dimensional 184. The location of each cell is defined by it's location in the x- 196, y- 182 and z-axis 186. In this example, the transformation from cell space to screen space is a 3-dimensional transformation, such that the cells (190, 192, 194) are seen as regions in 3-dimensional space.

The rendering of cells on the display may be implemented using dedicated graphics hardware with graphics processing units (GPU) running software written in a specialized programming language such as OpenGL shader language.

### Architecture

The representation of the cells is shown on a client device with suitable capabilities, such as a smartphone, desktop or tablet device. The client device may also be capable of capturing data using sensors such as but not limited to a camera. The client device could also be a smartphone, but may be a dedicated device without a display or user interface.

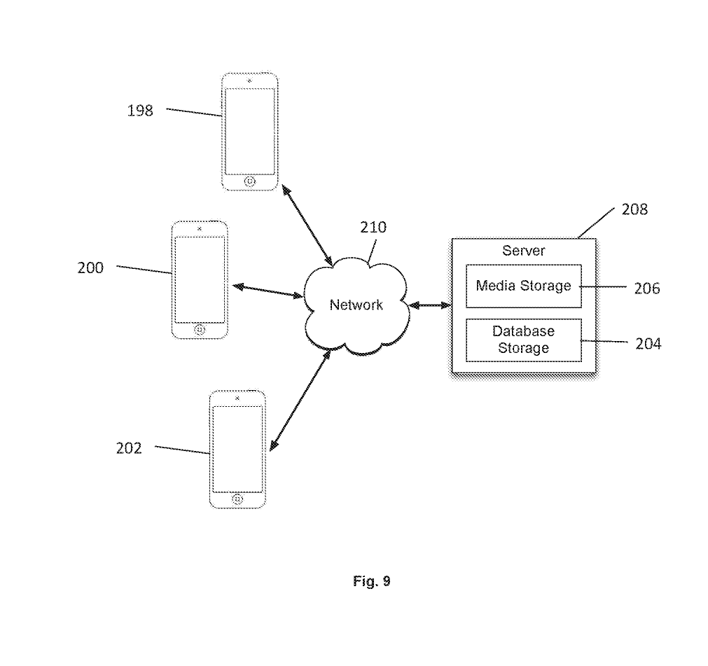

In an example implementation as shown in FIG. 9, there are a number of client devices 198, 200, 202 connected via a network 210 to a server device 208. In this example, the cell data is stored in media storage 206 within the server. For example, if the cell data is images, the images may be stored as compressed JPEG files on the hard disk of the server, or the image data may be stored as uncompressed data within a database. The media storage could be implemented as solid-state storage, and may be split and replicated between a number of server devices.

The meta-data associated with each cell maybe stored with the cell data (for example in the JPEG file), stored separately or a combination of the two. For example, it may be stored in a database 204. This allows searching and retrieval of the meta-data, for example to extract the name of the user who uploaded a specific cell. The database may be stored, for example, as a relational database, graph database or as a flat file.

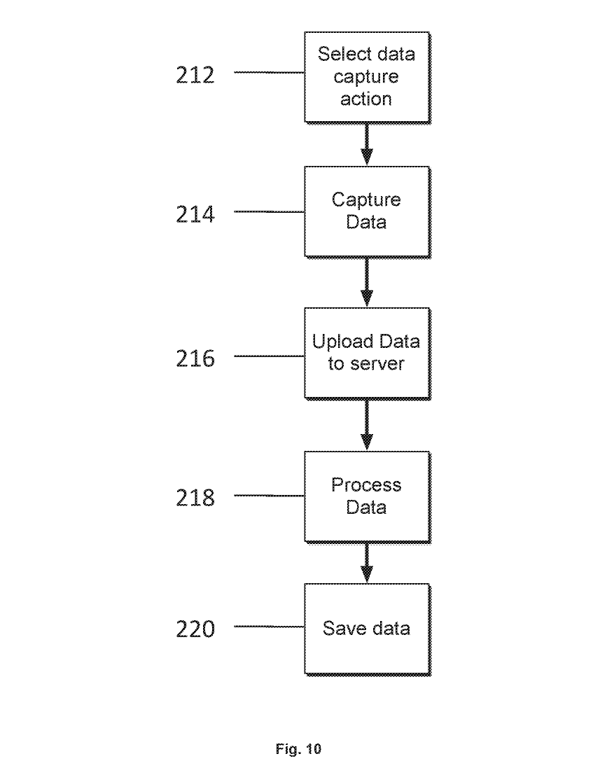

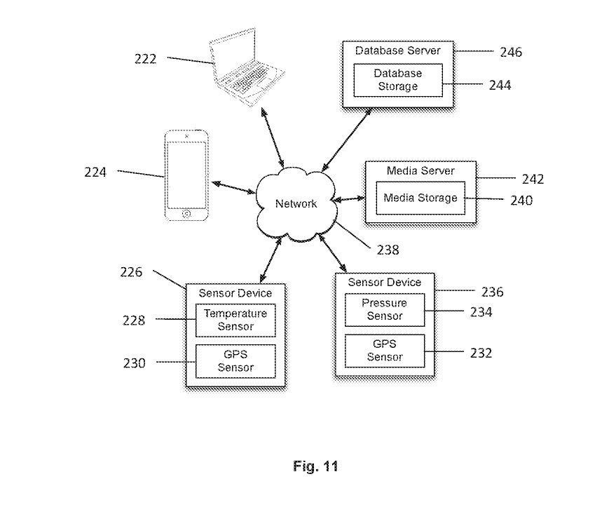

The client devices communicate with the server to both send and receive the cell data. As shown in FIG. 10, a user can upload data associated with a cell. First, the user selects a data capture action 212 by pressing a button on the user interface. The user then captures data 214 using an application provided as part of the operating system on the device or a custom application. The software application then sends the data across the network to the server device 208. The server then processes the data 218 before saving the data to the storage medium on the server 208. Processing of the data may include any one or more of the actions described herein, including but not limited to: generating presentation content data for outputting as a representation on a user interface, generating further metadata associated with the upload (for example metadata detailing when the content data was uploaded); generating further representations for different user interface viewing levels (zoom levels).

Another example architecture is shown in FIG. 11. Shown here is a smartphone client device 224, together with a desktop client device 222. In this example, the desktop device 222 is not capable of capturing data, therefore it only allows the users to view and navigate the cells. The server (which can be one or more servers) in this example is split into a database server 246 and media server 242 to reducing the storage and processing requirements of each server hence allowing for larger numbers of client devices to access the stored data. This may be further divided, such that there are multiple media servers, each holding data content for a number of cells. The media content may also be replicated between a number of servers, to allow for redundancy in case of hardware failure, and also to provide improved speed of access for client devices by increasing load capability.

A media server may be a device and/or software that simply stores and shares media. A database server may be a computer program that provides database services to other computer programs or computers, as defined by the client-server model. The term may also refer to a computer dedicated to running such a program.

FIG. 11 shows a separate database server, which may also be split onto a number of servers and replicated for the purpose of scalability or redundancy.

Shown in FIG. 11 are two sensor devices 226 and 236. Device 226 is a fixed device whereas device 236 is a mobile device 236. The fixed device has a temperature sensor 228 and a GPS sensor 230. In this example sensor device 226 is a dedicated device, not capable of presenting a user interface but can be used to capture temperature data and upload it to the media server at regular intervals, such as every minute. Each device could be assigned a specific cell location. For example the content data uploaded by each device may be associated with a particular cell.

For instance the device could be a mains powered embedded processor in a waterproof container mounted in a weather station.

Sensor device 236 may be, for example, a device attached to a moving vehicle that is capable of capturing air pressure and location. As the device moves, it transmits the sensor data along with the location meta-data to the servers. In this case, the cell coordinates will change according to the location of the device as obtained from the GPS sensor. In this way, a grid of cells representing a geographical map of the air pressure could be obtained. The location of a representation (e.g. a graphical representation) within the framework output on the user interface may therefore be dependent upon metadata associated with the data in the cell and therefore the representation of the cell may vary in position within the framework with time.

In any of the examples given herein the devices used to capture data may transmit and/or receive data to/from other devices, such as a server. This may be done using any suitable communications protocol and transmission apparatus, such as, but not limited to an RF transmitter/receiver.

Devices could capture any sensor data, such as electromagnetic field strength, sound intensity, humidity or user captured data such as responses to a questionnaire.

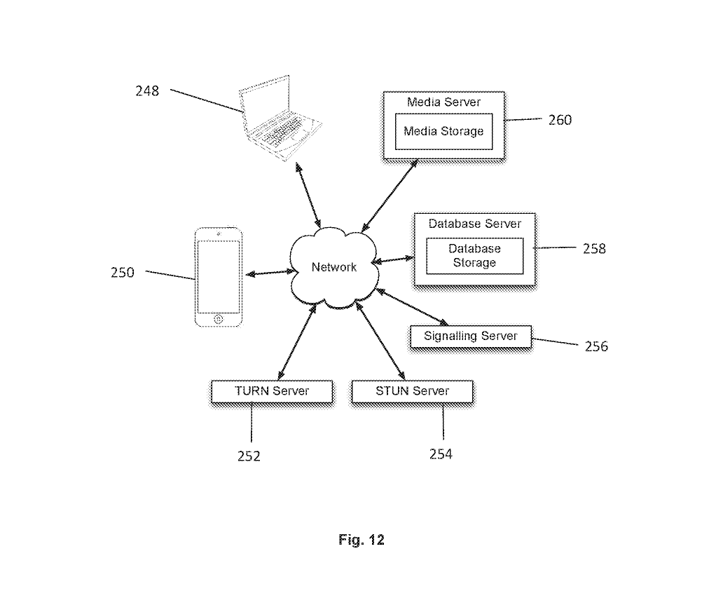

Devices connected to the network may be streaming devices. In this case, the device continually sends a stream of data, for example, a live-video stream. The live-stream may be sent to the server to be stored in the media storage, or may be sent directly (peer-to-peer) to other client devices. With reference to FIG. 12, a number of additional servers may be required to support live streams. When a client 250 wishes to start a live stream, it communicates to the signaling server 256 to obtain a unique stream identifier. A client wishing to view the live stream 248 will communicate with the signaling server 256 and database server 258 to obtain the unique stream identifier that references the live-stream they wish to view. The client 248 then uses this stream identifier to initiate the connection to the client device generating the live-stream 250, either directly (peer-to-peer) or via a relay server. In this example the live stream is implemented using WebRTC, but any suitable video streaming technology could be used such as HTTP live streaming, Flash Media server or a Wowza® streaming engine.

To enable reliable peer-to-peer communication, the client 250 may optionally connect to an intermediary server such as a STUN (Session Traversal Utilities for NAT) server 254 to obtain it's public IP address, which it then sends to the other peer 248 to allow direct communication. If peer-to-peer is not possible (due to network restrictions such as a firewall), the clients can utilize a different intermediary server such as a TURN (Traversal Using Relays around NAT) server 252 which acts as a relay passing data from one client to the other. Once communication is established between the clients, encoded video packets may are transferred, for example using WebM VP8 video encoding, although any suitable encoding can be used such as H.264, WMV or OGG Theora.

Audio packets may be transferred between clients using OPUS encoding, although any suitable encoding may be used, such as AAC or iSAC.

Another example architecture does not use a network. In this example a smartphone device contains local storage, so both the database and media for all the cells are stored on the client device. In this way it allows the device to capture data into the cells, and the same device to allow the user to navigate and view the cell data. In addition, the cell data may be fixed, so that it is part of the data associated with the software application, and copied onto the device when the software application is installed. In this way, the device is capable of collecting cell data and allowing the user to navigate through the cell space.

### Devices

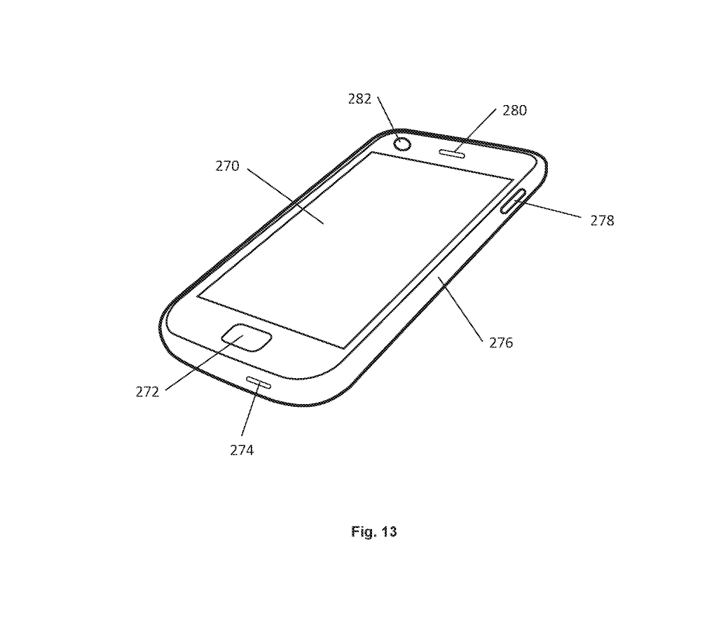

With reference to FIG. 13, a smartphone client device 276 is shown that may be used with any suitable example described herein. It has a display with integrated touch sensor 270 on which the user interface is displayed, and the user may use finger gestures to interact with the software application. The device in this example contains a camera 282, speaker 280 and microphone 274, however any suitable mobile user interface device may be used. To allow operation, a power button 278 and physical buttons 272 are provided in this example.

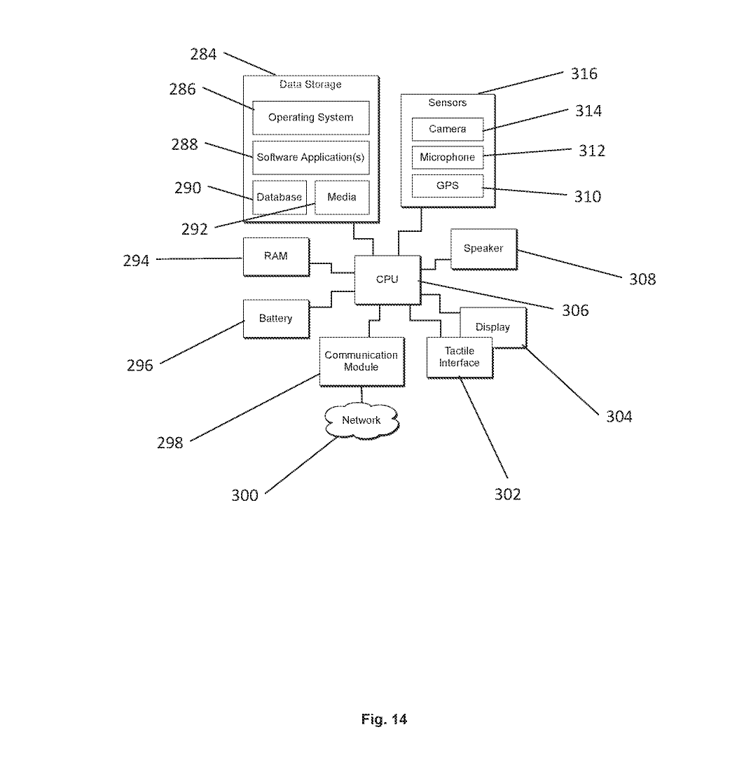

FIG. 14, shows a non limiting example of the functional modules of a smartphone for use with the methods devices and systems described herein. The functional modules shown in FIG. 14 may be included in another type of device. Furthermore, the client device may have some but not all of the functional modules shown. The client device may have further functional modules other than those shown in FIG. 14. The smartphone in this example contains non-volatile data storage 284 and a processor 306. Stored in the data storage on the device is the operating system 286 and software applications 288. The operating system facilitates running of the software applications on the processor, utilizing the RAM 294 to store intermediate calculations and cached data during operation of the software application. In addition, the smartphone contains a communications module 298, which utilizes wireless communication such as GPRS, WiFi or 4G to communicate with other connected devices through a network 300.

The smartphone contains a display 304 with a touch-screen 302 capable of receiving user interactions, together with a speaker 308 for playback of audio. The smartphone also contains sensors, for example a camera 314 and microphone 312 capable of capturing video and image data, also with a GPS location sensor 310. To allow mobile operation, the device contains a battery 296.

In this example there is local media storage 292 and database storage 290 integrated on the smartphone, allowing a full or partial copy of the cell database and cell data to be stored on the client device.

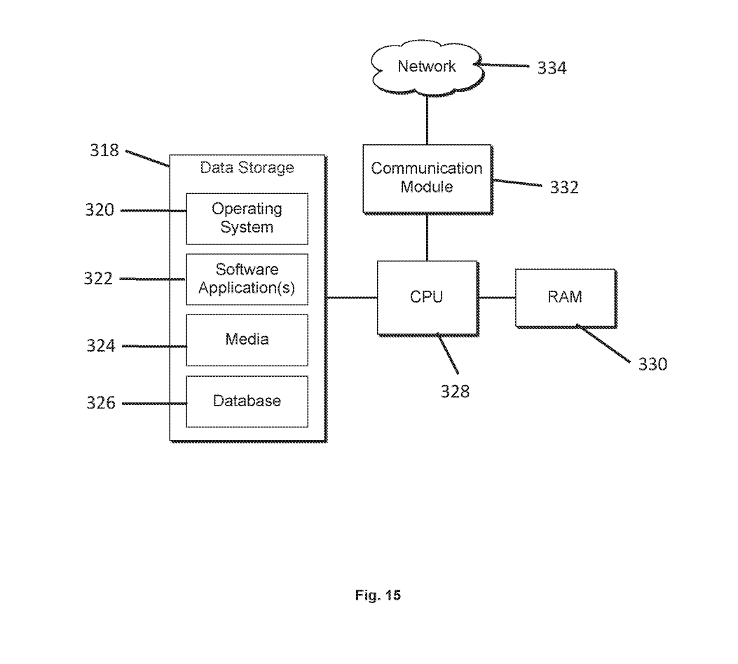

An example of a server device is depicted in FIG. 15. The server contains non-volatile data storage 318 and a processor 328. Stored in the data storage on the device is the operating system 320 and software applications 322. The operating system facilitates running of the software applications on the processor, utilizing the RAM 330 to store intermediate calculations and cached data during operation of the software application. In addition, the server contains a communications module 332 with wired communication such as Ethernet and wireless communications such as Wi-Fi and 4G to communicate with other connected devices through a network 334.

The cell data is stored in the data storage 326 on the server, for example as uncompressed data files, encoded files such as JPEG or MP4. The database storage 326 is intended to allow fast retrieval and searching of the cell meta-data, and can be implemented as relational database, graph database or flat files.

### Zoomable Tile Map

To enable fast rendering of the cells on the user interface, and efficient operation across a network, a tiled image map is used. At a given zoom level, it is required to display the cell presentation data on the user interface. For example, if square cells are used in a grid of 256 by 256 cells, when fully zoomed out this requires displaying 65536 cells on the user interface. Although it is possible to render each one individually, it would require a large processing resource. Instead, the present application takes advantage of the fact that when zoomed out, the representation of each cell appears very small on a user interface. The different viewing levels of the tile map use a pre-generated set of tiles which are combined and scaled versions of the representation data for the cells. Each of these tiles may be referred to as representations wherein the presentation content 104 for a cell 100 may be the lowest level tile. The presentation content of a cell may be referred to as a data group representation.

As the user zooms in and out, the tile level will change. The tile level is an integer value, ranging from zero when the user is fully zoomed in, to a maximum value, in this case 7, when the viewport is fully zoomed out. When rendering the user interface, the tiles for the current zoom level are displayed.

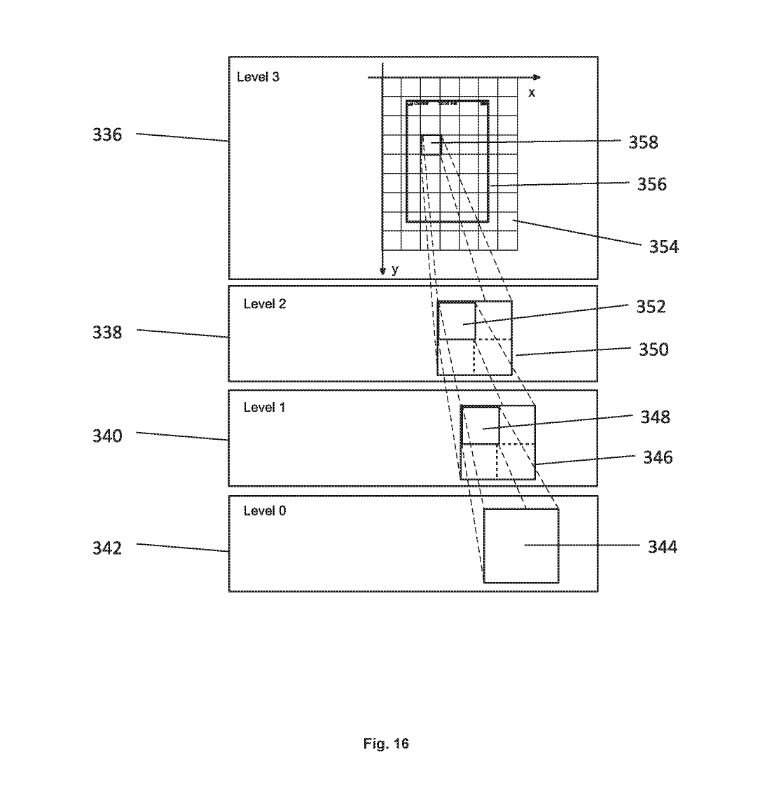

As shown in FIG. 16, level zero 342 is the original cell presentation data 344, so if the grid is 256 by 256 cells, there are 65536 tiles at level 0. Each tile at level one 340 is created by joining 4 tiles from level 0, therefore there are 16384 tiles at level 1.

The four tiles, in this example, are selected to form the combined tile at the next level based on each tile being adjacent to at least one other tile within the selection wherein each of the selected the tiles each occupy a different quadrant within. In other examples fewer or more tiles of a previous level may be used to generate a further level. Also, other tile selections may be used, for example four tiles in a row or a column. For the present example, at subsequent levels the tiles are joined versions of tiles of the previous layer, so at level 2 there are 4096 tiles, level 3 there are 1024 and then levels 4, 5, 6, 7 are 256, 64, 16 and 4 tiles respectively. In this way it can be seen that when fully zoomed out at level 7, there are only 4 tiles that are 256 by 256 pixels each, that contain scaled down versions of the cells.

In one example, if at least one of the four tiles that are combined to produce a tile at the next level are videos, then the next level tile will also be a video. If all four tiles are videos, then they are composited together to form a single video containing the four videos in 2×2 arrangement. If any of the four tiles are static data (for example images, composite images or website screenshots) then the static data is first converted to a video of the same length as the shortest video data object associated with the cell. To generate a video from a static image, the static image, for example is used as every frame in the video. Alternatively, a “Ken Burns” effect may be used to create a subtle moving video from static data.

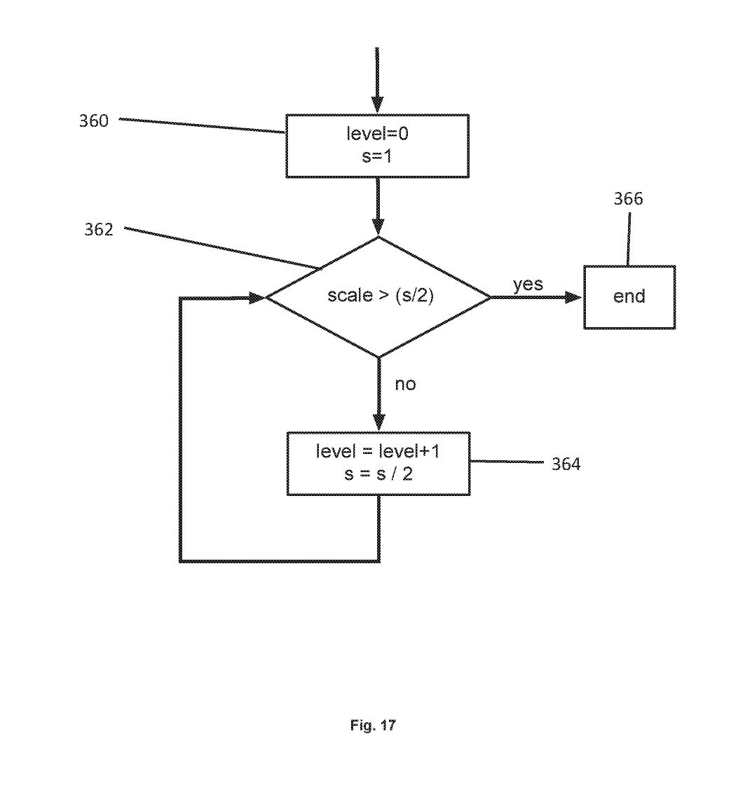

The appropriate tile level is determined by the current transformation scale of the viewport according to the process shown in FIG. 17. Initially in step 360 the tile level is set to zero, and a parameter ‘s’ is set to one. A comparison is done in 362, so if the current viewport scale is less than half of s the process continues; otherwise the current value of tile level is used and the process ends 366. In step 364, where the viewport scale is greater the s/2, the level is incremented by one, and the s parameter is halved and then flow returns back to the comparison 362. In this way, the value of the tile level is incremented to the correct value. For example, if the viewport scale is 0.2, running through the steps in FIG. 17 would proceed as follows:

At the first pass through the process: s=1, therefore s/2=0.5, the viewport scale 0.2 is smaller than 0.5 therefore the ‘tile level’ becomes 0+1=1, s becomes s/2=0.5

At the second pass through the process; s=0.5, therefore s/2=0.25, the scale 0.2 is smaller than 0.25 therefore the ‘level’ becomes 1+1=2, s becomes s/2=0.125

At the third pass through the process s=0.125, therefore s/2=0. 0.0625, the scale 0.2 is larger than 0. 0.0625 therefore the ‘level’ is determined as 2.

Accordingly, there is presented a method and for generating a representation for outputting on a user interface. The representation being for a collection of representations navigable via the user interface. These representations are the above said different tiles of the zoomable tile map including the lowest level tiles. The representations of the collection are arranged into a plurality of representation groups. These groups represent the tiles at a particular zoom level. Each representation group is associated with a representation framework for outputting via the user interface. Furthermore, each of the representations in each representation group is associated with a different position about the respective framework. The framework may be a grid, for example a grid of rectangular shaped representations.

The representations of the collection are also associated with a collection of separate data groups (cells). Each representation, be it a low level zoomed tile or a high level zoomed tile has at least part of its representation depicting one of the cells and each cell is represented in one of the tiles one each zoom level.

Each data group comprises at least a first data and metadata associated with the said first data. The first data may be content data such as, but not limited to, an image or a movie, for example one that has been uploaded from client device. Each data group is associated with a data group representation based upon any of the first data or metadata. This representation may be, for example a scaled down and/or cropped version of the first data. A first representation group of the said plurality of representation groups comprises the said data group representations. This is the group of tiles representing the highest zoom magnitude wherein the user can see the fewest data group representations, for example, just a single representation.

The method generates, using a processor, at least a first representation for at least one further representation group of the said plurality of representation groups. Preferably the method generates a first representation for each of the further representation groups. The further representation group may be any of the representation groups associated with different zoom levels after the highest magnitude of zoom. For example, the further representation group may be the next zoom level up from the zoom level that shows individual data group representations. The generation is done by firstly selecting a plurality of representations from a different representation group. This is preferably a representation group having a higher zoom magnitude (i.e. showing more detail). Each of the selected representations has an adjacent positional arrangement about the respective framework to at least one of the other representations in the said selection. Furthermore, each of the selected representations is associated with at least one data group representation in that at least part of the selected representation has at least some content of at least one data group representation.

The method then creates the first representation using at least the selected representations by, in any order: 1) downscaling each of the selected representations; and, 2) combining each of the selected representations to form the said first graphical representation. In this manner the new ‘first representation’ generated by the method is made up of downscaled versions of a plurality of representations from a previous representation group.

FIG. 16 shows an example of this processes. The data group representations are the representations at level 0. FIG. 16 only shows one of the data group representations. A further group of representations are the representations at level 1. FIG. 16 shows an example of the ‘first representation’ from this level 1 group being made from the cell representation shown at level 0 together with three other neighbouring representations.

At least one further representation group comprises a plurality of representations each associated with a different set of data group representations.

The method therefore provides a way of efficiently generating data for output as different resolution levels of data group representations.

In some examples the collection may be updated such that one representation may be generated for each further representation group upon a data group representation being input into the first representation group. Unlike a conventional digital map where if the map is changed then an entire new map will be created, the present method only replaces one tile per level.

Each of the further representation groups may comprise one or more representations that collectively comprise a downscaled version of each of the data group representations. In this way, each representation group may always have a representation associated with each of the data group representations. Thus, a single downscaled version of each data group representation is contained within one of the representations of each of the further representations groups.

The device storing the different tiles may output the required tiles to the client device with the user interface.

This may be accomplished by A) selecting a representation group based on a first output condition of the user interface; B) selecting one or more of the representations from the selected representation group based on a second output condition of the user interface; then c) outputting the selected one or more representations to the user interface. The conditions are associated with how the user is interacting with the user interface to access the representations, for example different viewing conditions on a graphical user interface. The first output condition may be associated with a zoom level of the user interface wherein the device managing/storing the tiles at the different zoom levels receives data associated with the first condition from the client device comprising the user interface. The first viewing condition may therefore be a resolution level at which the user is viewing the collection of representations.

The second viewing condition is associated with one or more data group representations which may be associated with the portion of the framework selected to be output by the user interface. The second viewing condition may be the representations selected to be viewed by the user on the user interface.

In one preferred example the at least one of the data group representations comprises moving image data such as video or live stream moving images.

Preferably the selected plurality of representations comprises a plurality of moving image representations wherein creating the first representation comprises creating a composite moving image representation.

This may be accomplished by selecting a plurality of moving image representations from the first representation group and determining a time period. Then, creating a time truncated version of at least one of the video representations; such that each of the said selected video representations comprises the same time length running period.

### Generating the Tiles

In this present application, the cell data may change regularly, therefore a mechanism to efficiently update the tiles is required. As has been described, there are potentially thousands of tiles at each level, so it is undesirable to update them all when a cell is changed. Instead, only the required tiles need to be changed.

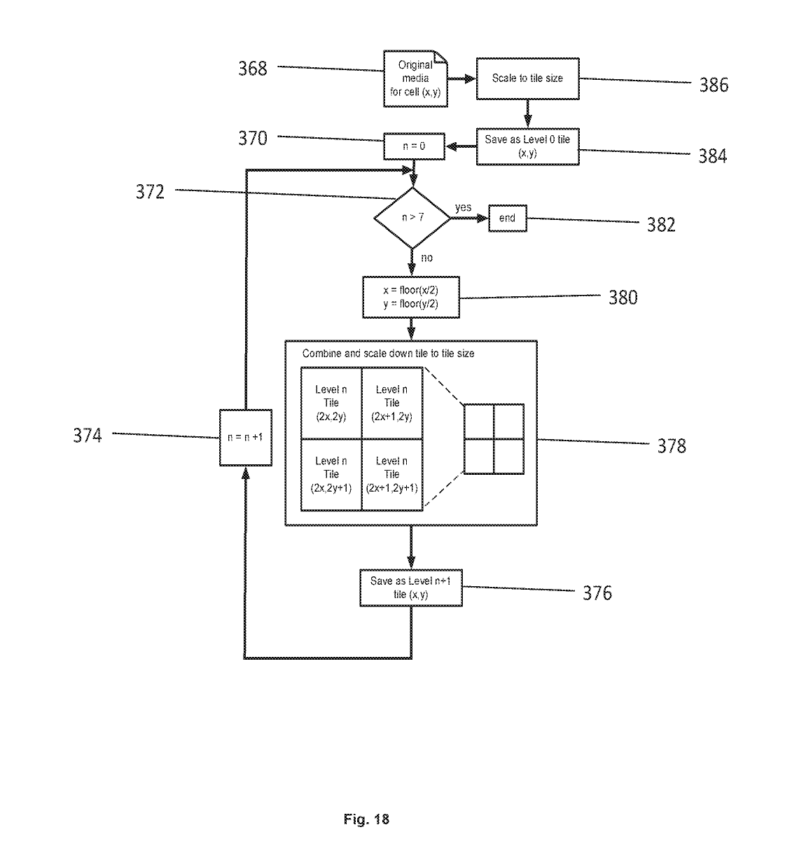

FIG. 18 demonstrates how the required tiles are generated, requiring only one tile to be updated at each level. When a cell's presentation data changes, this affects a single level 0 tile. So in this example, the original image 368 is updated at cell location (x,y). This original image is cropped and scaled to the size of the tiles in step 386, in this case 256 by 256 pixels. This is then saved as the level 0 tile in 384. A parameter n is set to zero in step 370

The location of the new level 1 tile is calculated in step 380, which is the (x,y) coordinates of the tile divided by two and the rounded down to the nearest integer. A new tile is created by joining the new tile with existing level 0 tiles, determined at the coordinates shown in step 378. This new tile is 512 by 512 pixels, so needs to be scaled down to 256 by 256 pixels. This is then saved as a level 1 tile in step 376. This process is then repeated, increasing the level each time, combining and scaling the tiles to save a new tile for each level.

This process can be used for any type of cell presentation data, for example for images and videos. The process for cropping and scaling the original media is detailed in FIGS. 4 and 5, as described earlier.

In some examples, the cells may be removed from the collection under certain circumstances. If a cell is removed from the collection, its associated cell representation is also removed. The cell may then be replaced with another cell, hence another cell representation. Typically, the new cell representation occupies the same position within the framework as the previous cell representation that has been removed. The previous cell may be removed based on a number of criteria including, but not limited to when it was uploaded, how many times users have interacted with the cell, how many times the metadata in the cell has been revealed or accessed by a search.

In one example, each cell has an associated date and time that represents when the cell is to be removed. Initially when a cell is created, it is given an expiry time some time in the future, for example in 7 days. When an activity is performed that is related to the cell, the expiry time is extended. When the expiry time is reached, the cell is removed.

As an example of updating the cell expiry time, each time the cell is viewed by a user other than the owner of the cell, the cell expiry time is extended by 10 minutes, up to a maximum expiry time of 2 weeks. The initial, extend and maximum times are configurable by administrator user input at any time to allow the management of cell expiry.

In another example, each cell contains a number representing the activity. This number is incremented based on user activity, such as viewing, or sharing the content, so that the number increases up to a maximum value. For example, each time a user views the cell, the activity number increases by one, if the user shares the cell the activity increases by ten. Optionally, the activity value decreases over time by a certain amount, for example, by five every 24-hours until it reaches zero. When the activity value reaches zero, the cell is removed.

Activity on the cell is not limited to that mentioned above, such that any activity can increase the interest level of a cell. For example, sharing the content, commenting on the cell or the cell content changing (for example a live stream started), liking or in any other way interacting with the cell. Alternatively, certain activity reduces the activity value, such as users down-voting the content or flagging it as inappropriate.

Any activity indirectly related to a cell may additionally extend the expiry time or update the activity level. For example, if the cell metadata contains a keyword that is frequently searched for, this may extend the expiry time. So as an example implementation, if the caption associated to a cell contained the word ‘cat’ and the term ‘cat’ was in the top 10 search terms, at regular intervals, for example every hour, the expiry time on the cell was extended by 1 minute. In another example, each cell could have a search relevance parameter, which is incremented by one each time a search is performed using keywords that match the meta-data in the cell. The search relevance parameter is reduced at regular intervals, so that when the given search term is not popular the search relevance parameter is reduced. The search relevance parameter could be used in the algorithm each cell contains a number representing the activity each cell contains a number representing the activity, each cell contains a number representing the activity to determine the expiry time of each cell.

Accordingly, there is presented a method for updating a collection of data associated with a pre-defined framework of representations. The framework may be a similar framework as that described elsewhere in this application, for example a grid of representations. The framework is configured to be output by one or more user interface devices and navigable by one or more users using the said one or more user interface devices.

Each representation is associated with a different position within the said framework.

The data in the collection arranged into a plurality of data groups wherein each data group comprises one or more of the data from the said collection.

Similarly, as described elsewhere, each data group is associated with a different representation of the said framework wherein the representation is based at least upon a data of the associated data group. This representation is the data group representation or ‘cell’ representation. The data of the data group may be similar to data described elsewhere herein, including but not limited to static image data such as bitmaps, TIFFs and JPEGS and moving image data such stored video files or live video feeds.

The method uses a processor to determine a parameter associated with a first of the said data groups. The parameter is based on one or more actions performed, on or using, at least one of the data in the said first data group. The action could be any one or more actions such as a search performed by a user. For example, a user searching for the word ‘dog’ throughout the data groups may be returned a map of all data groups with the term ‘dog’ in its metadata. The interaction of the search with the metadata may be an action that increases a ‘cell interaction parameter’. Other such parameters may be used including a ‘viewing parameter’ that gets increased in value when a user viewing the cell collection views the particular cell representation at the highest magnification (level 0 at FIG. 16). That cell viewing parameter of that cell is then increased, which in turn leads to a prolonged duration in the collection before the cell, and its cell representation on the grid, are removed.

Actions may include, but are not limited to: a search performed on at least one of the data of the first data group; a selection of the first data group by the user; an output of the associated representation on the user interface; a change in at least one of the data of the first data group.

The method then determines a time value associated with the said parameter. Preferably the time value is determined based on all such parameters that are affected by the said actions. This could be a fixed length of time or a length of time that may be updated based on further subsequent actions. The method then updates the collection of data at a time based on the time value. The update removes at least of one of the data from the first data group; wherein at least one of the removed data comprising the data associated with the representation of the first data group. The representation is associated with the first data group from the framework. Preferably, the time value is based on a number of types of action. For example, each cell is provided a default time value to expire and be removed from the collection when it is first uploaded. This default value may be the same or different to default time values given to other cells. The time value may be increased every time a further action is performed on the cell. Time values may be, for example, a set number of hours or days.

When the cell and its representation at level 0 are removed, the higher level tiles containing downscaled data of the representation will also be updated. This may be done at any time, for example immediately or when a user needs to access the particular tiles that should have changed, or upon a new cell being uploaded.

Preferably the method monitors all of the cells to see when they time out. Accordingly, the processor may determine a separate said parameter for each of the data groups and determine a separate time value associated with each said parameter. The processor may update the collection of data at a time based on the time value, for each of the data groups. It may do this by removing at least of one of the data from a respective data group. At least one of the removed data may comprise the data associated with the representation of the said data group.

The method may update the collection by removing the first data group from the collection (i.e. removing an entire cell of data). After removing a data group, the method may input a further data group into the said collection. The further data group associated with a further representation having the same framework position as the representation associated with the removed first data group. The method may remove the at least one of the data from the first data group after expiration of the time value. Determining the said parameter comprises updating an existing parameter associated with the first data group, i.e. a time parameter may already exist.

This method may be enacted by one or more processors operating on a server device and/or a client device described herein. Unlike existing systems that host images and media content for a number of interacting users and perpetually keep the data, the present method only allows users to view a set amount of data groups (cells) and drops the cells out of the collection after a particular time. This reduces the memory burden upon the system managing the cells. It also allows the collection to be populated with data that is more recent and more popular as old cells that are not interacted with are removed faster than those that are recently put up and are continually being viewed or being part of search results.

### Dynamic Tile Presentation

As the user navigates around the grid, different tiles appear and disappear from the viewport. Also, as the user zooms in and out, a new set of tiles is required when the level changes. Each tile is therefore defined as a coordinate in x- and y-axis, plus the level. As discussed, there are more tiles at the lower levels than at the higher levels.

When a tile comes into view, the device attempts to retrieve the presentation data from the local data storage, referencing the tile by coordinates and level. If the data is not present, it downloads the tile data from the server, by communicating over the network. It then saves the presentation data in the local data storage. In this way, the local device downloads and stores the tiles when required. If the user subsequently moves over the same part of the grid at the same zoom level, the device does not need to request the data from the server, hence improving speed of data presentation, and saving on bandwidth requirements.

When the zoom level is changed, if the correct tile at the new level is not stored in the local data storage, there is a potential for a delay in presenting the data on the user interface while it is retrieved across the network. This can be removed by presenting the tiles from either a lower or higher level, if available, and scaling them accordingly on the local device.

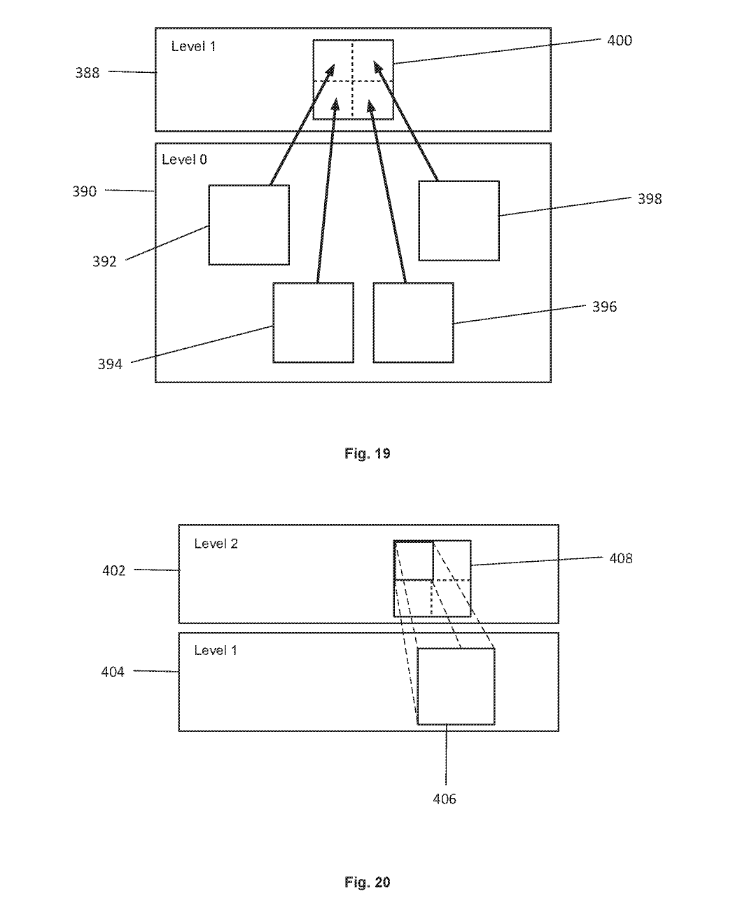

As shown in FIG. 19, the tile at level 1 is created from 4 tiles from level 0. If some or all of the corresponding tiles are available from level 0, a temporary tile 400 can be generated on the local device. This temporary tile is displayed while the actual stored tile data is retrieved across the network.

FIG. 20 demonstrates how a temporary tile can be generated from a higher-level tile. If a higher-level tile is available 408, the corresponding quarter of the tile can be scaled larger and used as a temporary tile 406. This generation of the temporary tile may include pixel interpolation or other image processing techniques to create the intermediate pixels.

In this present application, the cell data can change frequently, requiring an update to the presentation data, which would require the presentation device to update the tiles stored in the local storage.

One possible way to achieve this is to revalidate the local storage periodically, so for example, every 30 seconds the device could contact the server and download all the visible tiles. As the user moves to a new area, if the saved version of the tile is older than 30 seconds, this would prompt the device to download the required tiles from the server.

Another method is described that allows the device to only update the tiles that have changed, thereby reducing the network usage. In this method, a data file is used to record which cells have changed. To achieve this, the server keeps a version number of the grid, which is incremented when cells are updated. The version number could be updated every time a cell changes, but when many changes occur it could increase at a specified maximum frequency. For example it might only update at the most every 10 seconds, such that when a cell is updated the server waits for 10 seconds for any subsequent changes before updating the version number. In this way the number of version changes can be controlled. The server software can monitor the processor usage or bandwidth from the server, and reduce the version change frequency if the server is becoming overloaded.

The client device stores the current version number, and it compares this number with the current version on the server. This could be achieved by polling the server on a regular basis, for example every 10 seconds, or by establishing a connection to the server whereby the server notifies the client when a change is made.

When the client identifies the version number has been updated, it requests a data file from the server. This data file contains a list of the cells that have changed since the last version. The client then uses this data file to update the tiles that have changed.

If the tiles that have been updated are currently visible in the viewport, the client device immediately requests the updated tiles from the server, using the current tile temporarily while the updated tile is downloaded.

For changed tiles that are not visible in the viewport, if the changed tiles are in the local storage the client marks the tiles as invalid. In this way, when the user scrolls to reveal the invalid tiles, the client device can use the invalid tiles as temporary tiles while it requests the updated tiles.

The data specifying the cells that have changed since a previous version can be of any format. For example, it could be a text file containing a comma-separated list of cell coordinates, or a binary file, where each pair of bytes corresponds to the x and y cell coordinates of changed cells. In this implementation it is 256×256 pixel image, where a white pixel corresponds to an updated cell and a black pixel means it is not changed. The image is encoded using a lossless image encoding such as GIF or PNG.

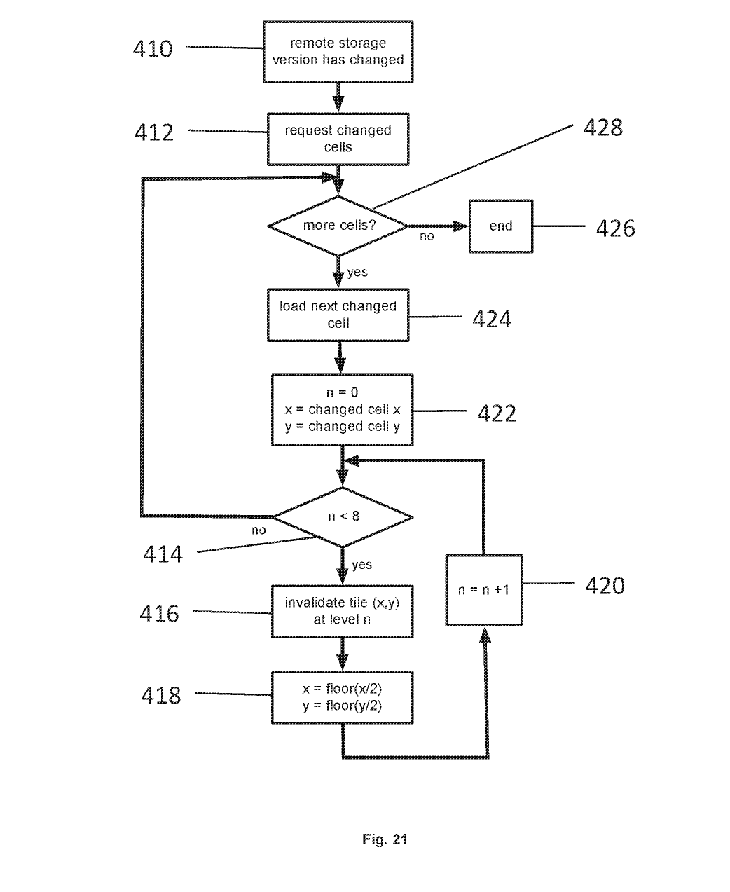

The data specifying the changed cells is processed to obtain a list of which tiles have changed, to allow the client device to know which tiles need invalidating. FIG. 21 describes the process for determining which tiles need invalidating. When the client detects that the version number has changed 410, it requests the data file detailing the changed cells 412. The client device then goes through each changed cell in a loop, until each cell has been processed. For each cell, the parameters x and y are set to the coordinates of the changed cell in step 424. The tile (x,y) at level 0 is then invalidated, by marking the tile in the local storage as invalid. The current x and y values are then updated in step 418, by dividing by two, and then rounding down to the nearest integer. The parameter n is the increased in step 420. While n is less than 8, steps 416, 418 and 420 are repeated. This method ensures that only the tiles showing the updated cells affect are marked as invalid. This method therefore identifies a cell that has been changed and therefore needs the copy of its cell representation on the local storage to be invalidated at the 0 level. After the level 0 cell representation has been invalidated, the method then sequentially invalidates all the higher level representations (tiles) containing content derived from the invalidated tile, for example, all the tiles containing downscaled versions of the invalidated tile. Although the method shown in FIG. 21 specifies n to 8 levels, in principle, other tile levels may be used. Furthermore, the tiles may not necessarily be in a square grid arrangement and/or higher level tiles may be formed from more or less than four lower level tiles.

Accordingly, there is presented a method for updating one or more representations stored on a first device. These representations may be any suitable representation including, but not limited to, a graphical representation described elsewhere herein, for example a moving image data such as live video or stored video file or static images such as JPEGs or Bitmaps. The method and the features described in the method may be modified according to any of the features described herein. The first device may be the client device described elsewhere herein. The one or more representations are for outputting on a user interface hosted by the first device. The user interface may be any suitable user interface, for example a GUI. The representations stored on the first device are at least part of a collection of representations navigable via the user interface. The first device is configured to communicate with a second device remote from the first device. The entire collection of representations may be stored on the second device and sent to the first device when the first device requires to output the particular representations on the user interface. The second device may be one or more server devices as described elsewhere herein.

The representations of the collection are arranged into at least one representation group. Preferably there may be more than one representation group. An example of different representation groups includes different groups of tiles for different zoom levels as described elsewhere herein. Each representation group is associated with a representation framework for outputting via the user interface. This framework may be a grid or any other type of framework as described herein. Each of the representations in each representation group is associated with a different position about the respective framework. For example, if the framework were a grid, then the representations may be separate videos, live video feeds or pictures, each occupying a different position on the grid.

The said representations of the collection are associated with a collection of separate data groups. These data groups may be the cells as described elsewhere herein. Each data group comprises at least a first data (for example content data) and metadata associated with the said first data similar to other example described herein.

Each representation is also associated with one or more data group representations. The data group representation is based upon any of the first data or metadata. For example, the data group representation may be scaled down and/or cropped version of the content data as described elsewhere herein.

The first representation group of the said at least one representation group comprises the said data group representations. This group of representations therefore has all of the cell representations and has the framework with the most number of sections for accommodating different representations. Referring to FIG. 16, this group would be the lowest level group 0.

The collection of data groups is configured to have different versions wherein a parameter identifying a version of the collection of data groups is stored on the first device and the second device. The parameter may be a version number or letter or alphanumeric combination such as version 1, 2, 3, etc, or version A, B, C etc or version 1 a, 1 b, 2a, 2b etc. The second device may update its version parameter according to a number of different events. These events may include, but not being limited to: a change of the data of one or more of the cells, a change of the representation of an existing cell, a removal of a cell, a upload of a new cell. The change could be, for example, a user updating the cell representation of an existing cell, one cell being replaced by another cell having a different cell representation, a re-ordering of the cell representation positions within the framework.

The method uses one or more processors to compare the parameter stored on the first device with the parameter stored on the second device. If the versions of the compared parameters are different, information from the second device is transmitted to the first device. This information is associated with a change in at least one of the data within the collection of data groups. The said one or more processors then updates the one or more representations stored on the first device based on the transmitted information. Furthermore, the version parameter on the first device is also updated to match the version parameter stored on the second device. The information may be requested by the first device by sending a communication from the first device to the second device. This request can be to request a file containing information providing details as to what cells have changed and/or what tiles have been updated. When a cell changes its representation or when a cell is removed or when a new cell is uploaded to the collection, the server updates the necessary tiles. If only a single cell is changed the the server will simply change one tile per level as previously discussed. The version parameter at the second device or server may, in some examples, only be updated when all of the necessary tiles have been updated by the server.

As described above, the initiation of the comparison of the version parameters may be accomplished in any suitable way including, but not limited to: the second device automatically sending the latest version parameter either when its own parameter gets updated or automatically at a particular repeating time period; the first device polling the second device at a repeating time period and/or upon when a particular event has occurred, for example the user initiating a program to view the collection of cells on the first device.

The comparison may be done on a processor of the first device or second device. The first device may send its own version parameter over for the second device to compare, alternatively the second device may send over its parameter for the first device to compare.

Once it has been identified that the version number on the first (client) device is out of date, a processor is used to determine which tiles need updating. This is particularly important when the first device stores local copies of certain tiles in a local memory, for example on a memory device on a mobile phone. The first device may only store certain tiles for certain levels or it may store all the tiles for all the levels. In preferred examples the first device only stores the tiles that are currently being or recently have been accessed by the user interface. This allows the first device to only store the relevant tiles at the appropriate level, hence save on storage space, but still allow fast retrieval of certain tiles that the user will most likely view through the viewport.

A data file is used to determine which cells have changed and hence which tiles in the entire collection are now invalid. As stated above, the client device (first device) may determine which tiles on which levels to request from the second device by using a data file sent from the second device. In another example, a further device other than the first device (for example the server device) may determine which tiles are invalid. This may be done by the first device sending a data file to the server device indicating a list of locally stored tiles. This list may be sent with a communication detailing the version number stored on the client device. The second device, after receiving the information may determine which cells have changed and, therefrom, determine which, if any of the currently stored cells need updating and then sends the updated tiles to the client device. This method may be used if the client device has limited processing power or capability. Upon receiving the new tiles, the client device then simply removes the old tiles and replaces them with the new ones.

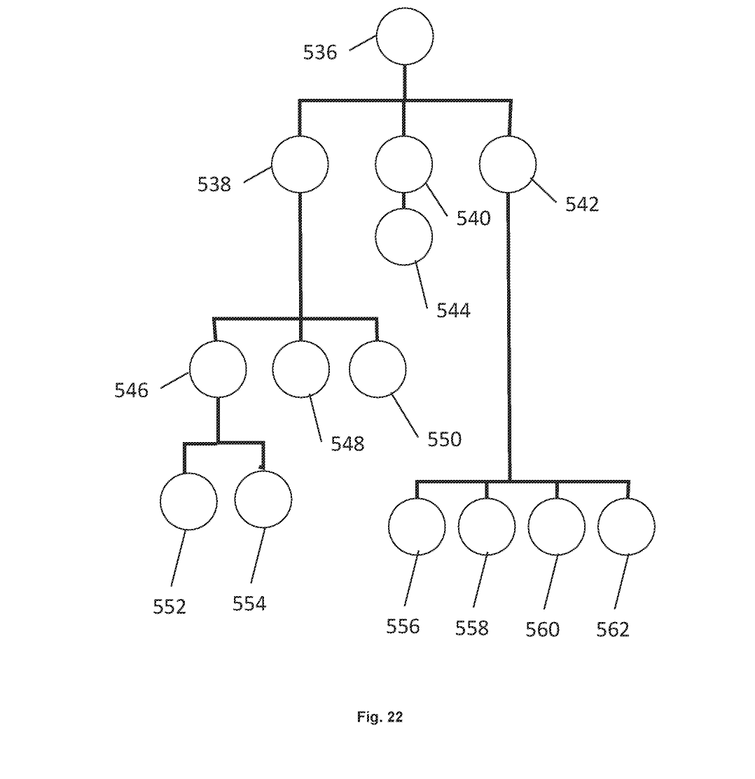

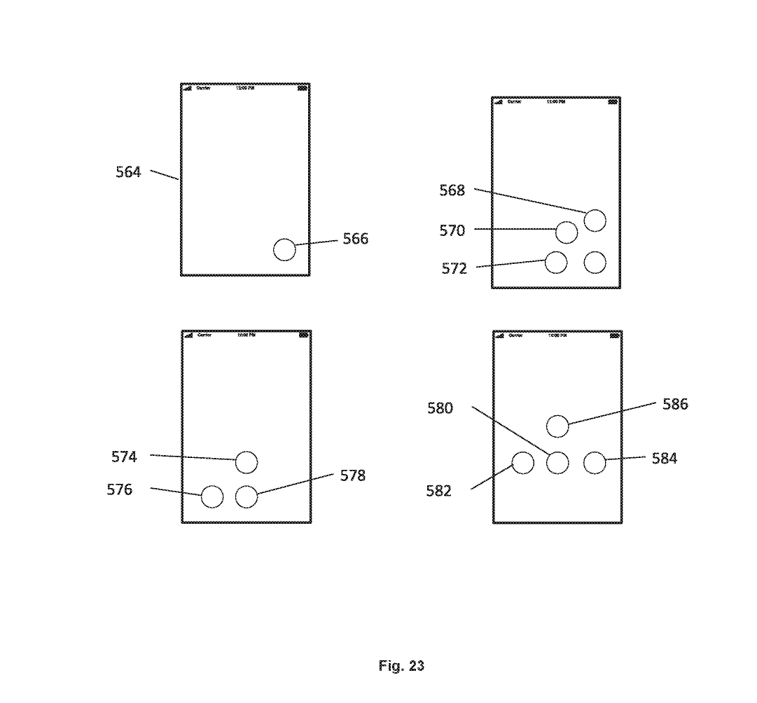

There is also presented herein a method for activating an activatable data object and a user interface for activating the said object. The activatable data object is a data object from a collection of nested data objects. The data objects are nested such that the selection or activation of at least one of the data objects in the collection presents and/or allows for the selection of other data objects in the collection that were previously un-selectable on the user interface. Each data object in the collection is therefore linked to at least one other data object from the said collection. The nesting may have a plurality of levels. An example of a nested arrangement of data objects is shown in FIG. 22 where the selection of object 536 allows for the selection of objects 538, 540 and 542. This may be presented on the user interface in any suitable manner including a radial menu such as that shown in the example in FIG. 23. The data objects in the nested collection may be any suitable data object selectable by a user interacting with the user interface. Data objects may be file folders. Data objects may be executable files that run a computer program. For example, in FIG. 22, data objects 536, 538, 540, 542 and 546 may be folders containing other sub folders or executable files whilst data objects 544, 548, 550, 552, 556, 558, 560 and 562 may be executable files.

A first data object of the collection is associated with a position on a user interface. This position may be a location on or near where the interface may output a representation of the first data object. The position may be a position of a hotspot on the user interface that is used to activate or otherwise select the first data object. This ‘hotspot’ may be a single point or a region on the user interface such as a pixel or a group of adjacent pixels on a graphical user interface. The user may activate the hotspot by interacting with the user interface at that position, for example by touching a user interface at the position of the hotspot or clicking a button of a pointing device (such as a mouse) on the hotspot.

In another example, the display device may be pressure sensitive such that it generates a signal proportional the force applied by the users finger. Under normal operation, the pressure signal level remains below a certain threshold. When the pressure on the user interface increases above a predefined threshold, this represents a ‘hard’ press and triggers the display of the first data object at the current location of the users finger. Optionally this also triggers activation of the first data object.

The user interface may be any suitable user interface such as, but not limited to, a graphical user interface or a user interface where a person interacts according to touch sensations, such as a haptic interface. In one example the GUI is also touch sensitive. The data objects may or may not be presentable on the user interface to the user, however in the examples described below the user interfaces are configured to graphically output representations of the data objects. The data objects may be presented graphically and/or via other means such as via haptic feedback.

The first data object of the collection is also associated with a first plurality of further data objects from the collection. These further data objects are the next level of data objects nested from the first data object, for example objects 538, 540 and 542 which are nested from object 566 in FIG. 23. An example of this could be where the first object is a folder of executable programs and the data objects in the folder are executable programs.

Each of the data objects from the said first plurality are associated with at least one different predetermined direction on the user interface from the position associated with the first data object. Each of the said at least one direction for each of the data objects of the first plurality are different from the directions of the other objects of the first plurality. Each data object may be associated with a plurality of directions. This may be a set of discrete directions or a range of directions. The directions are associated with the user interfaces dimensions in so far that a direction has to be one identifiable by the user interface. For example, for a GUI the direction is one within the graphical environment present by the GUI. An example is shown in FIG. 23 wherein a graphical user interface 564 is shown four different times as a user interacts with the interface 564. The top left example of FIG. 23 shows a single data object represented as an icon 566. The top right example shows the same GUI where the user has selected the icon and a further three icons 568, 570, 572, are displayed.

When a first input signal associated with the first position on the user interface device is received, and then subsequently a second input signal associated with a second position on the user interface (different from the first position) is received, a processor operatively connected with the user interface is used to determined a direction on the user interface. This is done by comparing the first position to the second position.

Each one of the icons 568, 570, 572 is displayed in a different position to the other icons at the same nested level and at a different angle about the user interface display to the starting icon 566. In this manner, the next level of nested data objects are radially arranged around the icon of the previous nested level. The icons 568, 570, 572 may be presented along a periphery of constant radius from the icon 566, or the said icons may be radially disposed at different radial distances from the initial icon 566 but still located at different angles about the icon 566. Each of the icons described above may not necessarily have to be displayed by the interface, however the data objects they represent are still associated with the different angles.

The signals received may be any signals, preferably electrical signals resulting from a user input. For example, a user touch input on a touch sensitive user interface; a press of a mouse button at the first position and the press of a mouse button at the second position; or a press of a mouse button at the first position and the release of the same mouse button at the second position. The touch input could be a touch of an object on the interface. The object may be, for example, a user's finger or a stylus. Any of the first or second signals could be based on the user initiating separate new touches on the interface or they may be part of a continuous user gesture. The user gesture could be a movement about the user interface, for example a swipe of a finger across the interface. The swipe takes a path from a beginning point where the user first touches the interface; to an end point where the user lifts the finger from the interface. The first signal may be any of the first touch position and the positions of the gesture along the gesture path from the first touch position up to the end point. The second signal may be the end point or any of the touch positions of the gesture after the first touch position wherein the second signal is received after the first signal.

Where the user makes a continuous gesture, there may be a plurality of signals output by the user interface, each signal representing different points along the path of the user gesture from the start point to the end point. The second signal may be selected from a plurality of signals representing a continuous touch gesture. The selection may be based upon a touch input being received at a predefined position on the touch interface wherein the second signal gets selected when it corresponds to the position at the said predefined position. This predefined position may be a single position such as a single pixel on a GUI, or it may be a region on the user interface wherein any signal received corresponding to a user input in the region may be selected as the second signal. In a preferred example, the first user input from a gesture that enters the region is used. The region may be an area of the user interface or a boundary of a region on the user interface. In one example the boundary may be set at a particular distance on the user interface from a graphical representation of the first data object. This boundary may exist as a line at a particular radius from the first data object. For example where a user gesture is traversed across a touch sensitive interface, the signal selected to be the second signal is the signal associated with the user touch at the position where the user gesture crossed the boundary line. The boundary line may exist continually all the way around the first object or may be a line segment existing part of the way around the first object, for example existing in a direction that the user is likely to swipe across the user interface.

In a preferred example the second signal is chosen from a plurality of signals by comparing the signal to one or more boundary positions on the user interface. When a signal is received that indicates a user input is upon one of the boundary positions, that signal is selected and its corresponding position on the user interface used to determine the said direction.

The direction is then used to determine the selection of the data object from the next nested level of data objects. Each of the next data objects, for example objects 568, 570, 572 in FIG. 23 are at different angular positions relative to the first data object 566. A comparison of: A) the direction determined by comparing the first position and the second position; to, B) at least one of the predetermined directions; is used to determine which data object of the next nested level is selected. This may be a comparison of the direction (derived from the first and second position) with all the predetermined directions and choosing the data object where the direction matches a predetermined direction for that data object. Alternatively, the predetermined directions may be compared in a sequential manner until one is matched.

The matching may be achieved only when the direction is the same as that of a particular predetermined direction. Additionally, or alternatively, the matching may be accomplished by identifying which predetermined direction is the closest to the direction. This may be done in any suitable way including evaluating the angles associated with the direction as described below.

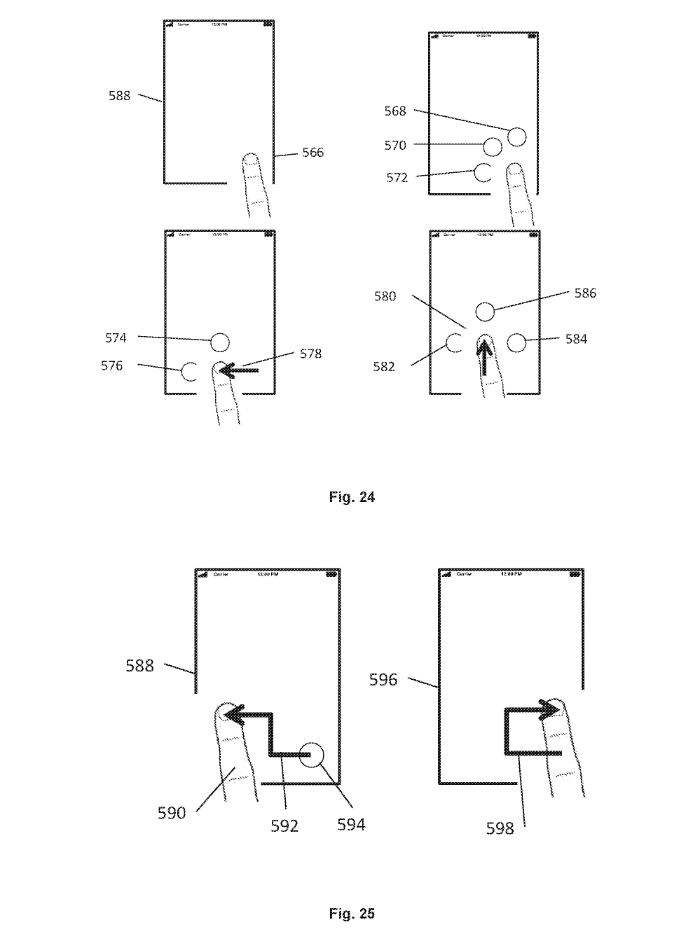

Additionally, or alternatively each of the predetermined directions associated with the data objects of the nested level may comprise a predetermined angle about the user interface. Each predetermined angle is different to other predetermined angles of the same nested level. The first position and second position, associated with the first and second signals resulting from user inputs, may be used to determine an angle of at least a portion of a continuous input gesture on a user interface. Matching is then accomplished by determining which predetermined angles corresponds to the newly calculated angle arising from the input gesture. Each data object in a nested level may have a range of predetermined angles that are used to select it. For example, each object in a nested level may be assigned a range of angles from the first position. The range of angles may be equally distributed for the objects. For example, in FIG. 24, each data object 568, 570, 572 may be allocated 45 degrees of angle about icon 566 wherein the centre of each icon is co-located within the centre of the angular distribution.

Unlike some existing user interfaces where a user needs to actually interact with a hotspot associated with the data object before that particular data object is selected, the method and user interface described herein provides a more user-forgiving way of determining which data object is needing to be selected. The user can swipe his or her finger across a user interface and have the system driving the user interface determine the direction or angle of at least a portion of that gesture and identify which object the user intends to select and select that data object without the user needing to actually interact with the hotspot.

The selection of a particular data object in this manner can be applied to a number of nested levels. For example, after the method has selected a data object from one nested level of objects using a part of a user gesture; the selected of that object identifies a further plurality of data objects nested within that selected object. The method may then use another part of the user gesture, similar to that described above, to determine which of the data objects in the next nested level to select.

An example of this can be seen in FIG. 24. FIG. 24 shows four time separated shots of a user interacting with a graphical user interface 588. In the top left shot, a user starts a touch gesture by touching icon 566. This icon is associated with a data object having a nested level of three further data objects 568, 570, 572, which are displayed on the same user interface in the top right hand shot. The user swipes his/her finger across to the left in the bottom left hand shot, to select the icon 572. The system identifies the selection of this icon by comparing the direction or angle as described above. A further nested level of data objects 574, 576 is then displayed. The user then continues the gesture upwards in order to select icon 574. The system uses this upwardly portion of the gesture to select the data object associated with icon 574, in a similar manner as for the selection of the previous data object. This use of different portions of the entire gesture to select different data objects of successive nested levels may continue until a data object in one of the terminal nested levels is selected and activated.

The method and user interface may be configured to select the data objects from the successive nested levels without outputting representations of the data objects. This allows the user to perform a fast swipe of his/her finger across the interface to select the target data object to activate without having to wait for the user interface to output the icons.

Where a portion of the gesture is used to select an object from a nested level after the first level, the signal representing the first position may be the same signal as the second signal used by the system to determine the direction for selecting the previous data object. For example, in FIG. 24, the second position of the user's finger that selected icon 572 can be used as the first position to determine the next direction for the selection of the next data object.

In other examples, a different first position may be used. In one example, a processor may analyse a plurality of signals arising from the gesture. In its analysis, the processor identifies significant changes in direction in the path of the gesture. This may be accomplished in any appropriate way including the following method. The processor may identify an X and a Y coordinate on the user interface for each position signal it is analysing. The processor then arranges these into a column and/or plots them on a standard X-Y Cartesian graph. The processor then calculates the second derivative d²y/dx² for the data and finds the maxima or minima of this function which gives the points of greatest inflection along the path. The points of greatest inflection indicate the points where on the user interface the user is changing the swipe direction towards another data object position on the screen. These positions may be used as end positions to determine angles and directions. They may also be used to compare to the position of the data objects on the user interface. For example, for one or more of the inflections, the processor may identify which of the data objects the inflection is closest to. This information may be used to select that data object or to compare again the data object selected with other methods as described above.

For example, the processor may determine an angle using the first method described above where the second position is taken where the gesture crossed a particular boundary. The angle according to this method is then used to select the appropriate data object. The processor also identifies an angle using inflection points. The inflection points of the gesture are only used if they are identified within a certain distance from the positions determined using the first method. Both of the angles are compared, and if they result in the selection of the same data object, the processor selects that data object. If they differ then the processor may return an output to the user interface informing the user that the gesture was not recognized. Other ways of determining angles using inflection points may be used including using an inflection position with a position determined using the ‘boundary’ method given above and calculating the angle between the two.

The method and user interface may be configured to provide a swipe radial menu as described below. The swipe radial menu is a non-limiting example of how the method described herein may be used wherein any of the features described in the example below may be used with other examples described above.

The swipe radial menu is user interface component that allows users to quickly select actions on a touch sensitive display using a number of modes of interaction. The radial menu has three methods of interaction to allow a simple and intuitive learning of its features, but also allows fast usage once learned. The menu allows selection of an action from within a nested set of options.

With reference to FIG. 22, the menu items are in a nested format, so that the top level has a number of items, each item having sub-items, which may or may not have any number of further sub-items. Any number of nested levels are possible. For example, when used in a word processor, the top level items 538, 540 and 542 may be ‘Format’, ‘Insert’ and ‘View’ respectively. When ‘Format’ 538 is opened, it reveals the sub-menu items ‘Font’ 546, ‘Paragraph’ 548 and ‘Style’ 550. The ‘Font’ item can then be opened to reveal the action items ‘Bold’ 552 and ‘Italic’ 554. When the actions are selected, the specified action is performed, for example when item 552 is selected the text in the word processor is made bold.

Interaction method 1 is shown in FIG. 23, which allows the user to perform short taps on the menu items. FIG. 23 shows a button 566 displayed on the user interface 564. In this example it is shown bottom-right of the user interface, but it could be at any location. In this method, the user performs a short tap and release on the button 566, for a duration of less than 200 ms. When released, the sub-menu items are shown 572, 570 and 568, optionally with a visualization effect such as fade or slide. The user can then perform another short tap on a sub-menu, to open the item. For example, a short tap on button 572 will cause sub-menu items to appear 576 and 574 as shown in FIG. 23 wherein button 572 is now referenced as button 578. Additionally, the unselected items are hidden (566, 570 and 568) leaving only the currently selected item and it's sub-items. The user can select a further sub-item by performing a short tap on the item 574, which will cause the sub-menu items to appear 582, 586 and 584 as shown in FIG. 23 wherein button 574 is now referenced as button 580. Again, the unselected item 576 is hidden. A short tap on the desired item will cause the action associated with the menu item to occur. For example, tapping on button 586 will trigger the action associated with this button. During this mode of operation, any interaction outside a button will cause all the menu items to disappear, leaving only the top level button 566.

Interaction method 2 allows the user to operate the menu without releasing their finger, but still allows the user to navigate the menu system without knowing what the menu items are. The user can hover their finger over a menu item, which after a delay will present the sub-menu items, allowing the user to then move over the desired sub-menu item. If the user does not want to select any of the sub-menu items, they can move their finger back to the higher level item, which causes the sub-menu items to disappear. For example, as shown in FIG. 24, the user touches button 566, and after a short delay (for example 400 milliseconds), the sub-menu items 572, 570 and 568 are shown as depicted in FIG. 24. The user can then move their finger onto the desired sub-menu item, without releasing the finger from the display, for example, as shown in FIG. 24, by sliding left the user can move the finger over button 572 (shown as 578 in FIG. 24). If the user holds the finger over this button for a short time, the sub-menu items 576 and 574 are shown. The user can now slide the finger over a sub-menu item and hold to open a further sub-menu, for example as shown in FIG. 24, over button 574 (shown as reference 580 in FIG. 24) to open the sub-menu items 582, 586 and 584. Alternatively, the user could move the finger back to the right to the location of the previous higher level button, thus causing the sub-menu items to disappear, in this case taking the user interface return back to showing the menu items 572, 570 and 568. At any point the user can release their finger from the display, which causes the action associated to the menu item to be performed, or if the finger is not over a menu item, all the menu buttons are closed except the top level button 566.

Interaction method 3 allows the user to select a menu item without removing their finger but additionally without needing to hover over a menu item. The user can touch the display on the button 594, and move their finger quicker than the required delay to show the sub-menu items, they can slide their finger onto the desired sub-menu item. Again, if they move their finger quickly, they can select a sub-menu item without lifting finger or hovering over an item. In this way, a user who is confident on the location of menu items can quickly select an item from multiple sub-menus in quick, fluid gestures.

As an example shown in FIG. 25, the finger traces left, up and then left, which the user can perform as quickly as they like. The initial left movement corresponds to selecting menu item 572 (shown in FIG. 24), but because the user does not hover over the item for long enough, the menu item is not displayed. Instead, the user then moves up, which corresponds to selecting menu item 574 (shown in FIG. 24). Again, the user moves left, which corresponds to menu item 582 (shown in FIG. 24). In this way, the user performs a single gesture to select within a nested set of menus, and no menu items are displayed because the user does not dwell for long enough on any menu item. If they did dwell on a menu item, the menu items would be displayed, as described in interaction method 2. When the user releases their finger, the action corresponding to the gesture is performed.

As another example, shown in FIG. 25 the gesture path 598 causes the action associated to menu item 584 (shown in FIG. 24) to be performed.

As an example, the user touches the screen at a location co-incident with a representation of the first data item on the user interface, this location is taken as the first touch location. The user keeps their finger on the display and moves the finger to begin a gesture. When the finger moves a distance greater than a threshold distance, for example 30 pixels, this causes the first data object to activate. When the first data object is activated, the sub-level objects are displayed. Each sub-level object is displayed radially, for example a distance of 100 pixels, from the first data object, each spaced by 45 degrees, such that the first sub-menu data object is to the left of the first data object, and a further two sub-level data objects are positioned in a clockwise manner. As the user continues to move the finger, the current touch location is taken as the second touch location, the distance between the first and second touch locations is calculated, using Pythagoras theorem by calculating the square root of the sum of the squares of the distances in x- and y-coordinates between the first and second touch locations. If the distance exceeds a second predefined threshold, for example 80 pixels, the angle of the second touch location relative the first touch location is calculated. This angle is calculated by using the inverse tan function, using the relative distance in x- and y-coordinates between the first and second touch locations. This calculated angle is then compared to the angles of each of the sub-level items, and the item with the closest angle is selected. Optionally, selected items are highlighted, for example by displaying a white outline around the representation of the data item on the user interface. If the selected sub-level item has further sub-level items, the data object is activated, and the nested sub-level items are displayed. The location of the activated sub-level item is then taken as the first touch location, with the current finger location as the second touch location. Again the distance between the first and second touch locations are calculated and the above method repeated to recursively open sub-level items. When the user lifts the finger from the screen, the currently selected data item is chosen and a signal sent to the software application to trigger the action associated with the selected data object.

### Heat-Maps

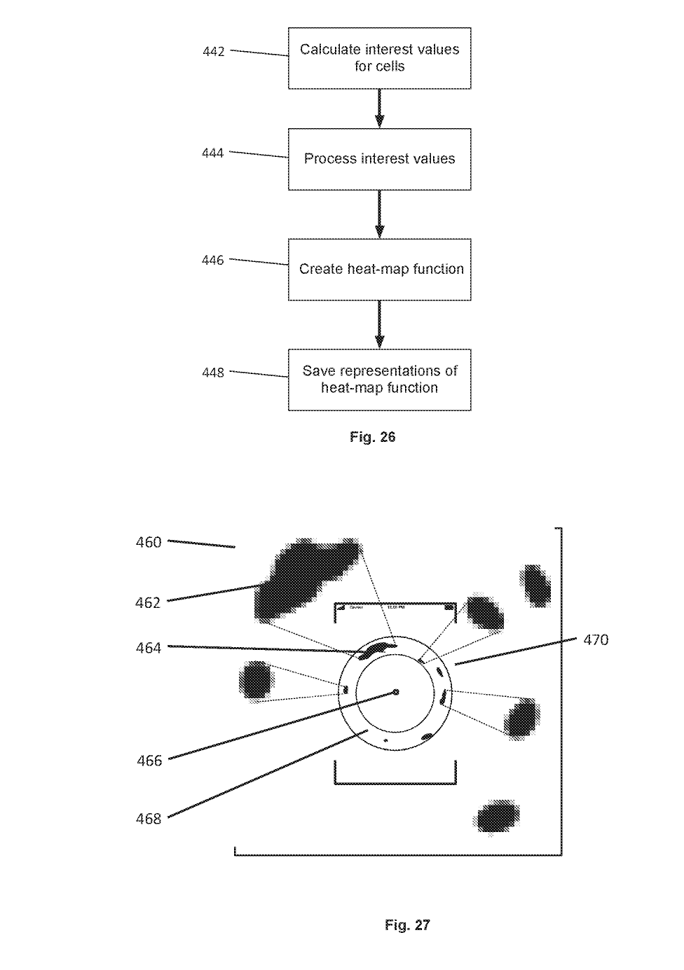

A heat-map is a function, for example a displayable function that represents cell relevance in the cell coordinate space. Each cell is assigned a relevance value or parameter, for example ranging from 0 to 100% (although other parameters may be used) that represents the relevance to a given criteria. There may be provided a plurality of heat-maps, each one representing different relevance criteria. Referring to FIG. 26, which indicates processing steps that may be performed by a computer system in creating one or more heat maps, a number of steps are involved. A first step 442 is to calculate interest values for cells, e.g. one or more interest values per cell. The interest value(s) may be a non-normalized relevance value for each cell, which is calculated according to the criteria for a specific heat-map. A second step 444 is to process the interest values. A third step 446 is to create a heat map function. A fourth step 448 is to save representations of the heat map function. Further details will now be explained.

### Cell Relevance Criteria

One such relevance criteria is popularity, such that cells that have more user activity are given a higher value. For example, each cell has an associated expiry time, and for each user activity performed related to the cell, the cell expiry time is extended for that cell. In this way, cells that have more activity (such as views, comments, likes etc.), have an expiry time further in the future. The non-normalized relevance value for each cell may be defined as the number of seconds from the current time to the expiry time.

A second relevance criteria value is based on key-phrase relevance, such that the relevance of a given cell is defined by how well a given keyword or phrase matches the content in the cell. This results in a set of heat-maps, each defining cell relevance for a given key-phrase. In one example, a set of one or more key-phrases may be defined for each cell. These may include key-phrases extracted from any text content associated with the cell (such as comments or captions), or automatically extracted key-phrases from media content such as video, audio and/or images. There are many established methods for determining keyword and phrase similarity, for example the Damerau-Levenshtein distance. The non-normalized relevance value may be inversely proportional to the key-phrase similarity. Any number of keyword matching algorithms can be used and/or combined to give a relevance value for a given cell as:

I=aI_{d}+bIₛ+ . . .

where I_{d},Iₛ are the various keyword matching algorithms, and the values a, b are scale values to change the relative effect of each metric.

A third relevance criteria is based on personalized relevance for each user. This may be based on user metrics such as age, gender, location, previously-watched videos, videos watched by friends etc., so that user-specific heat-maps can be generated. As an example, an ordered cumulative-frequency list of key-phrases may be generated based on the key-phrases of the cells viewed by a user's friends in the last week, or other finite time period. The heat-maps for each key-phrase are then blended together, to create a merged heat-map, such that each value in the resulting heat-map is a weighted average of the values from the same location in each of the incoming heat-maps. As a second example of a user-specific heat-map, the users are clustered using an established user-clustering technique, based on parameters such as demographics, search queries, videos watched etc. In this way, similar users are grouped together. A heat-map is then produced for each cluster, where cell relevance may be proportional to the volume of user activity on each cell by other users the cluster.

A fourth relevance criteria is generated from automatic computer vision techniques. For example, if the cell content is video or image media, a heat-map may be produced for each person in a group of people, where computer vision techniques are used to identify if that person's face appears in the media. The non-normalised relevance criteria value may be proportional to how well and/or how many times the person appears in the media.

A fifth relevance criteria is based on physical location. Each cell has an associated physical location. Therefore, the relevance value for a given location may be inversely proportional to the physical distance between the given location and the location associated with the cell.

A sixth relevance criteria is defined as a direct representation of the cell value. For example, if the cell content represented temperature, pressure or any other recorded value, the relevance value may be defined as the difference between a specified value for the current heat-map and the value recorded for the cell.

### Processing the Interest Values

After the non-normalized relevance values have been calculated for all the cells, these values are processed in step 444. One process that may be applied is to normalize the values between 0 and 100%, by using the global maximum and minimum relevance value for all the cells.

### Create Heat-Map Function

The heat-map function may be defined in step 446 so that a relevance value can be obtained for every point in the cell coordinate space. This may be as simple as using the relevance value for each cell (using zero where no cell is present), but in many cases the heat-map function may smoothly interpolate the values between the cell relevance values, which can be done with techniques such as using thin plate splines, Chugh's method or summation of Gaussians functions.

### Save Representations of Heat-Map Function

Although heat-maps can be generated dynamically, for the purposes of efficiency, each heat-map may be saved in step 448 to allow fast retrieval, transmission over a network and fast rendering of heat-maps on the user interface of a client device. In an example implementation, the heat-maps may be saved in 2-dimensional images, such that the intensity of a pixel in the heat-map image corresponds to the relevance level.

A number of representations of each heat-map can be generated to further improve efficiency. For example, the heat-map image can be smoothed by using a widely used image blurring algorithm (for example convolution with a kernel). In this example, each heat map is converted into three processed images, namely a grey scale heat map image, a smoothed version of the grey scale heat map, and a false colored version of the smoothed grey scale heat map.

### Heat-Map Overlay

To highlight relevant cells on the user interface, the heat-map images can be overlaid on the presentation in the user interface of co-ordinate space of the cells. The heat-map image is blended with the cell presentation underneath, such that areas of interest are highlighted to the user. In one example, the transparency of the cell presentation data is adjusted proportional to the relevance, so that highly relevant cells are opaque and non-relevant cells are transparent, or partially transparent, so the background (black) colour is seen.

For example, search-term relevance can be highlighted by overlaying the heat-maps associated with a user-entered search query. Firstly, the key-phrases are extracted from the search query, and the set of heat-map images obtained, one for each of the key-phrases in the search query. These heat-maps are then blended together, for example, such that each pixel in the resulting heat-map is a weighted average of the pixels from the same location in each of the incoming heat-map images. This blended heat-map is then overlaid on the presentation to highlight cells that match the search query.

Further blending of heat-maps can be performed, to enable multiple relevance criteria to be visualized, such as the cell popularity heat-map, query relevance and user-personalized heat-maps.

### Compass

In some embodiments, a compass or similar user interface component may be provided. A compass is a user interface component that may be used to display data to the user to enable navigation around a large data set. The compass uses heat-map data.

In one example, with reference to FIG. 27, the compass 468 is a circular region displayed in front of (e.g. overlaid on) the content on the user interface 470. Reference numeral 466 indicates its centre. This Figure is showing the origin and scale of the currently displayed content on the user interface, relative to the entire cell space 460, such that the scale is showing roughly a third of the quadrant, and the viewport is centred in the cell space. The heat map image is distorted by use of a function to wrap the rectangular heat map image into a torus shape. For example, a high relevency region 462 is not in the current viewport, but is represented by the region 464 in the compass torus. The distort function is calculated so that the direction of the region in the torus is the substantially the same direction as the region in the quadrant, thus enabling the user to use the compass 468 to navigate to areas of high relevancy in the heat-map.

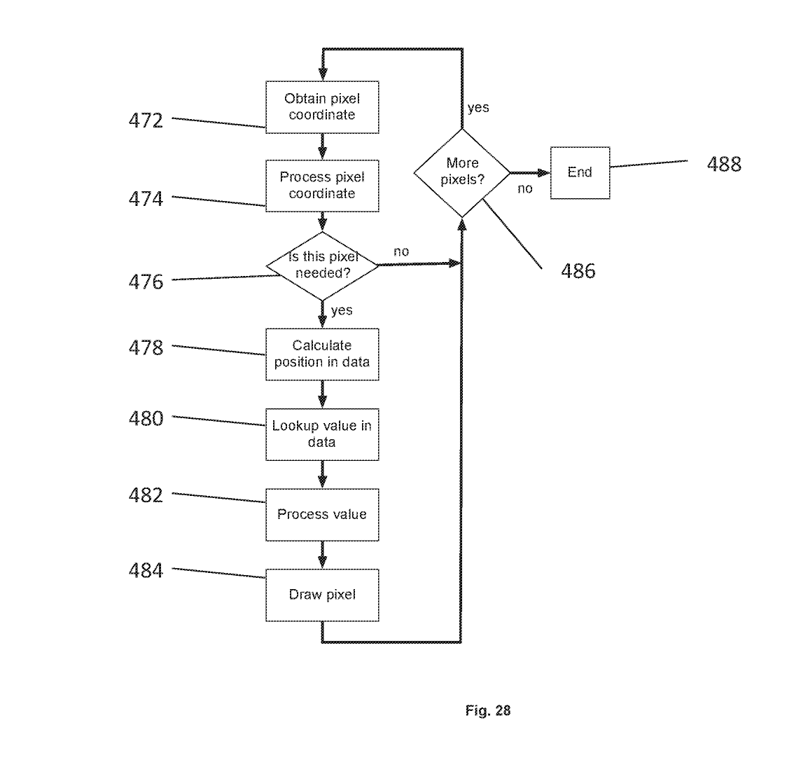

The compass function may be implemented using the processing steps shown in FIG. 28. For each pixel on the screen, the pixel coordinate is obtained (step 472.) The pixel coordinate is then processed to create a set of values (step 474.) A test is then performed and the pixel is discarded if it fails the test (step 476.) If the pixel passes the step 476 test, the position of the pixel in the data is calculated (step 478.) Using the position, the value of the data is then obtained (step 480) and processed (step 482.) The pixel is then drawn on the user interface 484. This is repeated for all the pixels within the boundary of the compass or lens 468.

For a circular compass or lens, step 474 obtains a vector from the centre 466 of the lens to the pixel on the user interface:

d̅=t̅−0.5

where d is the vector from the pixel to the center of the lens, and t is the pixel location in screen coordinates. In this example, the screen coordinates are scaled between zero to one, so (0.5, 0.5) is at the centre of the screen. The length of d is then calculated as l.

A value p is then calculated:

p=(l−i)/c

where l is the length of d, I is the inner circle size and c is the circle width. If p is less than zero, the pixel is discarded.

The position in the data is then calculated as:

$$\overline{q} = \overline{a} + \overline{d} \cdot \frac{p}{l}$$

where q̅ is the location in the data, ā is the location of the center of the lens in the cell coordinate space, d and p are the values given in equations 10 and 11.

Heat-maps may be created and stored for later retrieval, and updated periodically or when cell data or meta-data changes, Alternatively heat-maps can be created dynamically on the server or client device, in response to a specific request such as a relevance to a specific key-phrase.

The processed heat-map images are requested from the remote server if they are not available on the local device. Caching mechanisms are used to optimize performance and to ensure that new heat map images are only downloaded if they have been modified. In this example, the heat map images are be served from the remote server using HTTP via a web server. When the request is made to the server, the client passes the modification timestamp (if available) of the current heat map image. According to the HTTP standard, the server responds with either the new image, or a message notifying the client that the image has not changed. The client then saves the new heat map image, setting the last modified time to the current time.

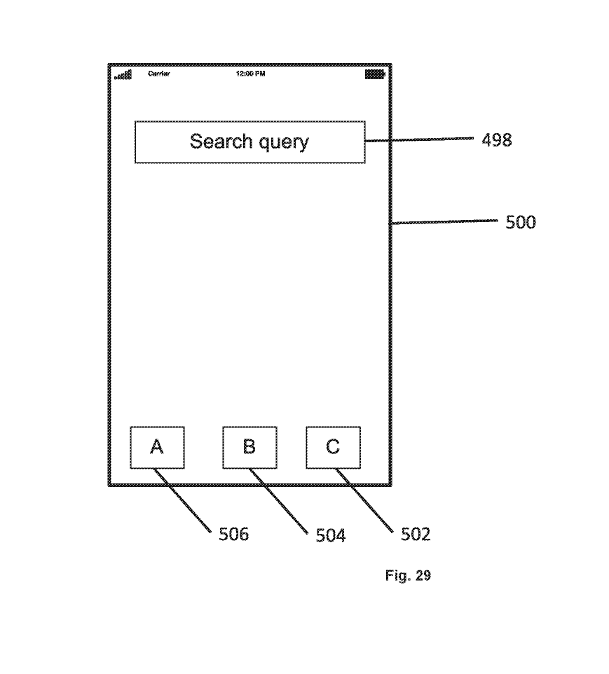

The compass may present one or more data sets. The currently displayed data set can be selected either automatically or by user interaction. In this example, with reference to FIG. 29, the user selects the current data set by selecting a mode in the user interface 500, by tapping a button 506, 504 or 502. Alternatively the user may enter a keyword search in the box 498, which would cause the lens to display the keyword heat-map data.

Any of the processing devices described herein may comprise one or more electronic devices. An electronic device can be, e.g., a computer, e.g., desktop computer, laptop computer, notebook computer, minicomputer, mainframe, multiprocessor system, network computer, e-reader, netbook computer, or tablet. The electronic device can be a smartphone or other mobile electronic device.

The computer can comprise an operating system. The operating system can be a real-time, multi-user, single-user, multi-tasking, single tasking, distributed, or embedded. The operating system (OS) can be any of, but not limited to, Android®, iOS®, Linux®, a Mac operating system, a version of Microsoft Windows®. The systems and methods described herein can be implemented in or upon computer systems. Equally, the processing device may be part of a computer system. Computer systems can include various combinations of a central processor or other processing device, an internal communication bus, various types of memory or storage media (RAM, ROM, EEPROM, cache memory, disk drives, etc.) for code and data storage, and one or more network interface cards or ports for communication purposes. The devices, systems, and methods described herein may include or be implemented in software code, which may run on such computer systems or other systems. For example, the software code can be executable by a computer system, for example, that functions as the storage server or proxy server, and/or that functions as a user's terminal device. During operation the code can be stored within the computer system. At other times, the code can be stored at other locations and/or transmitted for loading into the appropriate computer system. Execution of the code by a processor of the computer system can enable the computer system to implement the methods and systems described herein.

The computer system, electronic device, or server can also include a central processing unit (CPU), in the form of one or more processors, for executing program instructions. The computer system, electronic device, or server can include an internal communication bus, program storage and data storage for various data files to be processed and/or communicated. The computer system, electronic device, or server can include various hardware elements, operating systems and programming languages. The electronic device, server or computing functions can be implemented in various distributed fashions, such as on a number of similar or other platforms.

The devices may comprise various communication capabilities to facilitate communications between different devices. These may include wired communications (such as electronic communication lines or optical fibre) and/or wireless communications. Examples of wireless communications include, but are not limited to, radio frequency transmission, infrared transmission, or other communication technology. The hardware described herein can include transmitters and receivers for radio and/or other communication technology and/or interfaces to couple to and communicate with communication networks.

An electronic device can communicate with other electronic devices, for example, over a network. An electronic device can communicate with an external device using a variety of communication protocols. A set of standardized rules, referred to as a protocol, can be used utilized to enable electronic devices to communicate. A network can be a small system that is physically connected by cables or via wireless communication (a local area network or “LAN”). An electronic device can be a part of several separate networks that are connected together to form a larger network (a wide area network or “WAN”). Other types of networks of which an electronic device can be a part of include the internet, telcom networks, intranets, extranets, wireless networks, and other networks over which electronic, digital and/or analog data can be communicated.

The methods and steps performed by components described herein can be implemented in computer software that can be stored in the computer systems or electronic devices including a plurality of computer systems and servers. These can be coupled over computer networks including the internet. The methods and steps performed by components described herein can be implemented in resources including computer software such as computer executable code embodied in a computer readable medium, or in electrical circuitry, or in combinations of computer software and electronic circuitry. The computer-readable medium can be non-transitory. Non-transitory computer-readable media can comprise all computer-readable media, with the sole exception being a transitory, propagating signal. Computer readable media can be configured to include data or computer executable instructions for manipulating data. The computer executable instructions can include data structures, objects, programs, routines, or other program modules that can be accessed by a processing system Computer-readable media may include, but are not limited to, non-volatile storage media in various forms (e.g., optical, magnetic or semiconductor storage media, hard disk, optical disk, magneto-optical disk), volatile media (e.g., dynamic memories) and carrier waves that can be used to transfer such formatted data and/or instructions through wireless, optical, or wired signalling media, transmission media (e.g., coaxial cables, copper wire, fibres optics) or any combination thereof.

The terms processing, computing, calculating, determining, or the like, can refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. Users can be individuals as well as corporations and other legal entities. Furthermore, the processes presented herein are not inherently related to any particular computer, processing device, article or other apparatus. An example of a structure for a variety of these systems will appear from the description herein. Embodiments are not described with reference to any particular processor, programming language, machine code, etc. A variety of programming languages, machine codes, etc. can be used to implement the teachings as described herein.

An electronic device can be in communication with one or more servers. The one or more servers can be an application server, database server, a catalog server, a communication server, an access server, a link server, a data server, a staging server, a database server, a member server, a fax server, a game server, a pedestal server, a micro server, a name server, a remote access server (RAS), a live access server (LAS), a network access server (NAS), a home server, a proxy server, a media server, a nym server, network server, a sound server, file server, mail server, print server, a standalone server, or a web server. A server can be a computer.

One or more databases can be used to store information from an electronic device. The databases can be organized using data structures (e.g., trees, fields, arrays, tables, records, lists) included in one or more memories or storage devices.

It will be appreciated that the above described embodiments are purely illustrative and are not limiting on the scope of the invention. Other variations and modifications will be apparent to persons skilled in the art upon reading the present application. Moreover, the disclosure of the present application should be understood to include any novel feature or any novel combination of features either explicitly or implicitly disclosed herein or any generalization thereof.

1. A method implemented by a computing system including one or more processors and storage media storing machine-readable instructions, wherein the method is performed using the one or more processors, the method comprising:
providing data representing a plurality of data groups or cells configured to be displayed by one or more user interfaces of client devices as a framework which is navigable by one or more users using said one or more user interfaces, each data group or cell comprising content data and a data group or cell representation of said content data for presenting the content data within the said framework at respective positions,
wherein a plurality of representation groups are provided, each associated with a respective zoom or resolution level of a user interface viewport, in which a first representation group associated with a first zoom level comprises the data group or cell representations and in which a second representation group associated with a second, different, zoom level comprises second zoom level representations generated by selecting a plurality of the first zoom level data group or cell representations having an adjacent positional arrangement in the framework and combining the selected representations, wherein at least one of the selected first zoom level data group or cell representations comprises moving image data, and the second zoom level representation which is generated from the plurality of the first room level data group or cell representations comprises a composite moving image representation.

2. (canceled)

3. The method of claim 1, further comprising providing a third representation group associated with a third, different, zoom level and having third zoom level representations generated by selecting a plurality of the second zoom level representations having an adjacent positional arrangement in the framework and combining the selected representations.

4. The method of claim 3, wherein at least one of the selected second zoom level representations comprises a composite moving image representation, and the third zoom level representation which is generated therefrom comprises a further composite moving image representation.

5. The method of claim 1, wherein at least one of the selected first or second zoom level representations comprises static image data, and in which the composite moving image representation is generated by converting the static image data to video data.

6. The method of claim 4, wherein the static image data is converted to video data of substantially the same length as the duration of the shortest moving image data.

7. The method of claim 1, wherein two or more of the selected first zoom level data group or cell representations comprise moving image data, and in which the composite moving image representation is generated by (i) determining a time period, and (ii) creating a time truncated version of at least one of the moving image data representations such that each of the selected moving image representations comprise the same time period.

8. (canceled)

9. (canceled)

10. The method of claim 1, wherein the second, and any further zoom level representations are pre-generated.

11. The method of claim 1, wherein the one or more representations for the different levels are arranged as tiles representing a navigable grid framework, the tiles of the first representation group being arranged as an n×n grid, and the tiles of the second representation group being arranged as an m×m grid, wherein m is a factor of n.

12.-21. (canceled)

22. The method of claim 1, further comprising updating one or more data groups or cells by:
determining a parameter associated with one or more data groups or cells based on one or more actions performed on, or using, data associated with the respective data groups or cells;
updating one or more data groups or cells at a time based on the parameter, wherein the updating step comprises removing the one or more data groups or cells, or
wherein the updating step comprises replacing the one or more data groups or cells with a different data group or cell.

23. (canceled)

24. (canceled)

25. The method of claim 22, wherein the parameter is an expiry time value, wherein the expiry time value is extendable based on the one or more actions, and wherein the updating step is performed at a time corresponding to the expiry time value.

26. The method of claim 22, wherein the parameter is a number which is increased based on user activity and which decreases over time, wherein the updating step is performed when the number reaches zero.

27. The method of claim 22, wherein the actions comprise user actions comprising one or more of:
a search performed on the one or more data groups or cells;
a selection of the one or more data groups or cells;
an output of the associated representation of the one or more data groups or cells on the user interface;
a change in one or more data groups or cells;
a liking of one or more data groups or cells; and
commenting on one or more data groups or cells.

28. The method of claim 1, further comprising:
providing a heat map representing the relevance of the data groups or cells to a given criteria; and
outputting one or more representations to a client device for rendering on a user interface as the navigable framework, and
outputting at least part of the heat map to the client device by overlaying it on respective data groups or cells.

29. (canceled)

30. The method of claim 28, further comprising presenting a user interface component on the user interface indicating a navigation direction towards one or more relevant portions of the heatmap.

31. The method of claim 30, wherein the user interface component comprises a two dimensional image comprising one or more pixels the appearance of which is or are indicative of the degree of relevance in the navigation direction.

32. (canceled)

33. A method implemented by a computing system including one or more processors and storage media storing machine-readable instructions, wherein the method is performed using the one or more processors, the method comprising:
providing data representing a plurality of data groups or cells configured to be displayed by one or more user interfaces of client devices as a framework which is navigable by one or more users using said one or more user interfaces, each data group or cell comprising content data and a data group or cell representation of said content data for presenting the content data within the said framework at respective positions; and
updating one or more data groups or cells by:
determining a parameter associated with one or more data groups or cells based on one or more actions performed on, or using, data associated with the respective data groups or cells; and
updating one or more data groups or cells at a time based on the parameter.

34. The method of claim 33, wherein the updating step comprises removing the one or more data groups or cells, or replacing the one or more data groups or cells with a different data group or cell.

35. (canceled)

36. The method of claim 33, wherein the parameter is an expiry time value, wherein the expiry time value is extendable based on the one or more actions, and wherein the updating step is performed at a time corresponding to the expiry time value.

37. The method of claim 33, wherein the parameter is a number which is increased based on user activity and which decreases over time, wherein the updating step is performed when the number reaches zero.

38.-64. (canceled)

65. A non-transitory computer-readable medium having stored thereon computer-readable code, which, when executed by at least one processor, causes the at least one processor to perform a method, comprising:
providing data representing a plurality of data groups or cells configured to be displayed by one or more user interfaces of client devices as a framework which is navigable by one or more users using said one or more user interfaces, each data group or cell comprising content data and a data group or cell representation of said content data for presenting the content data within the said framework at respective positions,
wherein a plurality of representation groups are provided, each associated with a respective zoom or resolution level of a user interface viewport, in which a first representation group associated with a first zoom level comprises the data group or cell representations and in which a second representation group associated with a second, different, zoom level comprises second zoom level representations generated by selecting a plurality of the first zoom level data group or cell representations having an adjacent positional arrangement in the framework and combining the selected representations, wherein at least one of the selected first zoom level data group or cell representations comprises moving image data, and the second zoom level representation which is generated from the plurality of the first zoom level data group or cell representations comprises a composite moving image representation.
